(19) United States
(12) Patent Application Publication
(10) Pub. No.: US 2021/0097628 A1
(43) Pub. Date: Apr. 1, 2021

(54) SYSTEM FOR IDENTIFYING EVENTS AND PERFORMING RELATIONSHIP ACTIONS

(71) Applicant: Wells Fargo Bank, N.A., San Francisco, CA (US)

(72) Inventor: H. Brock Kolls, AlpharettA, GA (US)

(21) Appl. No.: 15/438,405

(22) Filed: Feb. 21, 2017

(51) Int. Cl. G06Q 50/00; G06F 17/30; G06Q 10/10

(52) U.S. Cl. CPC G06Q 50/01; G06Q 10/109; G06F 17/3053; G06F 17/30604

(57) ABSTRACT

This disclosure is directed to techniques that include automatically researching information about personal or business contacts for a relationship manager or other person, proposing relationship actions to be performed for such contacts, and/or executing relationship actions on behalf of the relationship manager. A method may include receiving, by a computing system, information about a plurality of contacts; storing, by the computing system, the information about the plurality of contacts; monitoring, by the computing system, a plurality of information sources to identify, based on the stored information, further information associated with at least one of the plurality of contacts; determining, by the computing system, and based on the identified further information, a proposed relationship action for a target contact; outputting, by the computing system and for display, a user interface that includes information about the about the target contact and the proposed relationship action.

### TECHNICAL FIELD

This disclosure relates to computing networks and managing information over computing networks.

### BACKGROUND

Advances in communication and information technology has made communicating with and/or maintaining contact with personal and business contacts easier, and in some cases, has made it possible to keep in touch with a larger number of people. However, more contacts tend to make staying well informed about events relating to those contacts more difficult.

### SUMMARY

This disclosure is directed to a computing system that performs techniques that include automatically researching information about personal or business contacts for a relationship manager or other person, proposing, through a user interface, relationship actions to be performed for such contacts, and/or executing relationship actions on behalf of the relationship manager. In some examples, a computing system may present a news feed of information about personal business contacts via a user interface of a computing device in communication with the computing system. The news feed may include information derived from information and/or known facts about each contact. The news feed may alternatively, or in addition, include information derived from research performed by the computing system, which may include web scraping, web harvesting, or web data extraction. Further, in some examples, the news feed may include one or more proposed relationship actions. In some examples, a relationship action may include a communication, or the electronic or physical delivery of a service or an item of value. The relationship manager may authorize or approve a relationship action for a particular personal or business contact via the user interface of the computing device, and, in response, the computing system may initiate performance of the relationship action for that contact.

In one example, a method comprises: receiving, by a computing system, information about a plurality of contacts; storing, by the computing system, the information about the plurality of contacts; monitoring, by the computing system, a plurality of information sources to identify, based on the stored information, further information associated with at least one of the plurality of contacts; determining, by the computing system, and based on the identified further information, a proposed relationship action for a target contact, the target contact being at least one of the plurality of contacts for which further information has been identified; outputting, by the computing system and for display, information sufficient to create a user interface, wherein the information sufficient to create a user interface includes information about the target contact and the proposed relationship action; detecting, by the computing system, input authorizing the proposed relationship action for the target contact; and responsive to detecting the input, initiating, by the computing system, the proposed relationship action.

In another example, a system comprises: at least one processor; and at least one storage device that stores instructions that, when executed, configure the at least one processor to: receive information about a plurality of contacts, store the information about the plurality of contacts, monitor a plurality of information sources to identify, based on the stored information, further information associated with at least one of the plurality of contacts, determine, based on the identified further information, a proposed relationship action for a target contact, the target contact being one of the plurality of contacts for which further information has been identified, output, for display, information sufficient to create a user interface, wherein the information sufficient to create a user interface includes information about the target contact and the proposed relationship action, detect input authorizing the proposed relationship action for the target contact, and responsive to detecting input, initiate the proposed relationship action.

In another example, a computer-readable storage medium comprises instructions that, when executed, configure one or more processors of a computing system to: receive information about a plurality of contacts; store the information about the plurality of contacts; monitor a plurality of information sources to identify, based on the stored information, further information associated with at least one of the plurality of contacts; determine, based on the identified further information, a proposed relationship action for a target contact, the target contact being one of the plurality of contacts for which further information has been identified; output, for display, information sufficient to create a user interface, wherein the information sufficient to create a user interface includes information about the target contact and the proposed relationship action; detect input authorizing the proposed relationship action for the target contact; and responsive to detecting input, initiate the proposed relationship action.

The details of one or more examples of the disclosure are set forth in the accompanying drawings and the description below. Other features, objects, and advantages of the disclosure will be apparent from the description and drawings, and from the claims.

### BRIEF DESCRIPTION OF THE DRAWINGS

FIG. 1 is a conceptual diagram illustrating an example system for identifying events associated with personal or business contacts and performing relationship actions with respect to those contacts, in accordance with one or more aspects of the present disclosure.

FIG. 2 is a block diagram illustrating another example system for identifying events associated with personal or business contacts and performing relationship actions with respect to those contacts, in accordance with one or more aspects of the present disclosure.

FIG. 3A is a conceptual diagram illustrating an example user interface presented by an example computing device in accordance with one or more aspects of the present disclosure.

FIG. 3B, FIG. 3C, FIG. 3D, FIG. 3E, and FIG. 3F are conceptual diagrams illustrating additional example user interfaces presented by an example computing device in accordance with one or more aspects of the present disclosure.

FIG. 4 is a flow diagram illustrating example operations performed by an example computing system in accordance with one or more aspects of the present disclosure.

### DETAILED DESCRIPTION

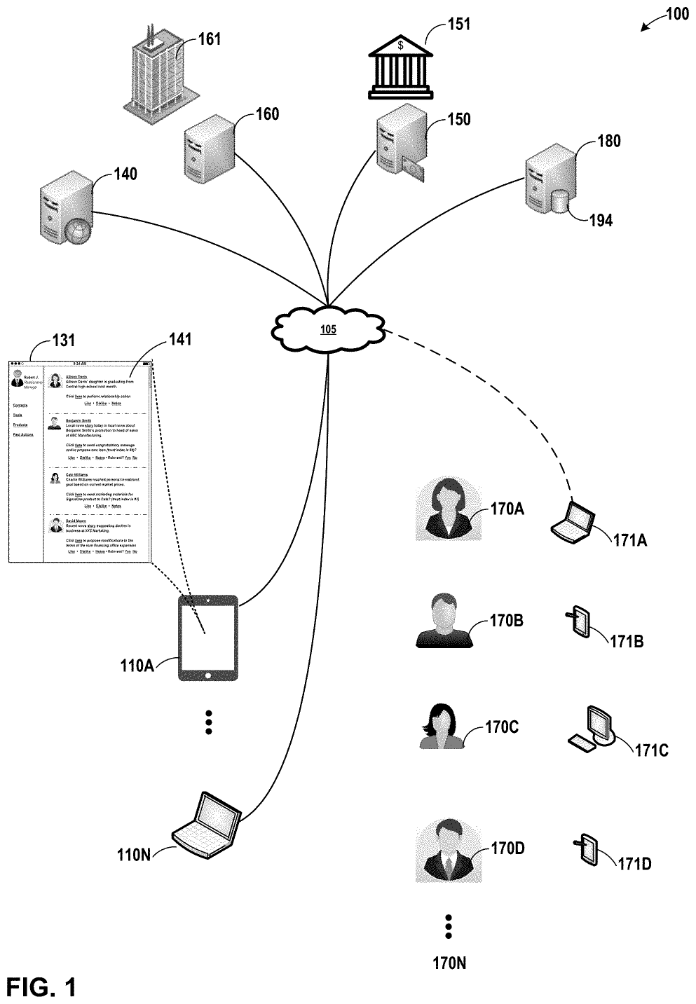

FIG. 1 is a conceptual diagram illustrating an example system for identifying events associated with personal or business contacts and performing relationship actions with respect to those contacts, in accordance with one or more aspects of the present disclosure. In the example of FIG. 1, system 100 includes one or more computing devices 110A-110N (collectively referred to as “computing devices 110”) in communication, via network 105, with one or more other systems, including one or more information source computing systems 140, one or more service provider computing systems 160, one or more financial services computing systems 150, and one or more computing systems 180. FIG. 1 illustrates one example implementation of system 100. Other implementations of system 100 may be appropriate in other instances. Such implementations may include a subset of the components included in the example of FIG. 1 and/or may include additional components not shown in FIG. 1.

Contacts 170 may include contact 170A through contact 170N (collectively referred to as “contacts 170”). Each of contacts 170 may be a person having a personal or business relationship with one or more users operating computing devices 110. For instance, with respect to a user operating computing device 110A, contacts 170 may include customers, clients, business partners, or other people that a user of computing device 110A works with to further business, personal, charitable or other interests. In some examples, one or more contacts 170 may operate a computing device (e.g., contact 170A may operate contact computing device 171A) that is connected to network 105. As used in FIG. 1, “N” represents any integer so that references to “computing devices 110” and “contacts 170” may each refer to any number of computing devices and any number of contacts, respectively.

Although functions and operations described in connection with system 100 of FIG. 1 may be described or illustrated as being distributed across multiple devices in FIG. 1, in other examples, the features and techniques attributed to multiple devices in FIG. 1 may be performed internally, by local components of one or more of such devices. Similarly, one or more of such devices may be described as including certain components that may, in other examples, be attributed to one or more other devices. Further, certain operations, techniques, features, and/or functions may be described in connection with FIG. 1 as being performed by specific components, devices, and/or modules. In other examples, such operations, techniques, features, and/or functions may be performed by other components, devices, or modules. Accordingly, some operations, techniques, features, and/or functions attributed in the description below to one or more components, devices, or modules may be attributed to other components, devices, and/or modules, even if not specifically described herein in such a manner.

Network 105 may be the internet, or may include or represent any public or private communications network or other network. For instance, network 105 may be a cellular, Wi-ZigBee, Bluetooth, Near-Field Communication (NFC), satellite, enterprise, service provider, and/or other type of network enabling transfer of transmitting data between computing systems, servers, and computing devices. One or more of client devices, server devices, or other devices may transmit and receive data, commands, control signals, and/or other information across network 105 using any suitable communication techniques. Network 105 may include one or more network hubs, network switches, network routers, satellite dishes, or any other network equipment. Such devices or components may be operatively inter-coupled, thereby providing for the exchange of information between computers, devices, or other components (e.g., between one or more client devices or systems and one or more server devices or systems). Each of the devices or systems illustrated in FIG. 1 may be operatively coupled to network 105 using one or more network links. The links coupling such devices or systems to network 105 may be Ethernet, Asynchronous Transfer Mode (ATM) or other types of network connections, and such connections may be wireless and/or wired connections. One or more of the devices or systems illustrated in FIG. 1 or otherwise on network 105 may be in a remote location relative to one or more other illustrated devices or systems.

Computing devices 110 may enable users to interact with, browse, and/or use information or resources available over a network (e.g., network 105). For instance, one or more of computing devices 110 may, at the direction of a user, perform financial advisory tasks, perform wealth management tasks, perform financial reporting tasks, browse for information, communicate with others, perform calculations, analyze data, monitor or check or process a user's personal communications, control other devices, perform a physical task or cause one to be performed, access other information or resources, and view or research information about one or more personal business contacts, and perform tasks relating to such personal or business contacts. One or more of computing devices 110 may pair with and/or communicate with other devices, and may send control signals to other devices or systems.

Each of computing devices 110 may be implemented as any suitable computing system, such as a mobile, non-mobile, wearable, and/or non-wearable computing device. One or more of computing devices 110 may represent a smart phone, a tablet computer, a computerized watch, a computerized glove or gloves, a personal digital assistant, a virtual assistant, a gaming system, a media player, an e-book reader, a television or television platform, an automobile, or navigation, information and/or entertainment system for an automobile or other vehicle, a laptop or notebook computer, a desktop computer, or any other type of wearable, non-wearable, mobile, or non-mobile computing device that may perform operations in accordance with one or more aspects of the present disclosure. One or more of computing devices 110 may represent a computing device that performs operations described herein as the result of instructions, stored on a computer-readable storage medium, executing on one or more processors. The instructions may be in the form of software stored on one or more local or remote computer readable storage devices. In other examples, one or more of computing devices 110 may perform operations using hardware, firmware, or a mixture of hardware, software, and firmware residing in and/or executing at each of computing devices 110.

Although computing devices 110 may each be a stand-alone device, computing devices 110 may be implemented in any of a wide variety of ways. For example, one or more of computing devices 110 may be implemented through multiple devices and/or systems. In another example, computing devices 110 may be, or may be part of, any component, device, or system that includes a processor or other suitable computing environment for processing information or executing software instructions. Also, some computing devices 110 may be illustrated or described as similar devices, one or more of computing devices 110 may be different from others, and may be implemented using widely diverse hardware, software, and other components.

One or more information source computing systems 140 may include web servers, information servers or portals, corporate information servers or portals, government information servers or portals, information gateways, content distribution systems, or any other computing system capable of responding to requests for information over network 105. In some examples, information source computing system 140 may be or may include news websites, newspaper web sites, online forums, social media web sites, government web servers providing property or other government information and records, or any other network-accessible information repository. Information source computing system 140 may be implemented through any suitable computing system, such as one or more server computers, mainframes, workstations, cloud computing systems, server farms, server clusters, or any other suitable computing system. In the example of FIG. 1, one or more computing devices connected to network 105, such as computing devices 110 and/or computing system 180, may communicate with information source computing system 140 over network 105 to access services provided by information source computing system 140.

One or more service provider computing systems 160 may include a device or system that operates to perform functions on behalf of one or more service providers 161. Service provider computing system 160 may be implemented through any suitable computing system, such as one or more server computers, mainframes, workstations, cloud computing systems, server farms, or server clusters. Service provider computing system 160 may be operated or controlled by service provider 161, and service provider 161 may be any type of business, organization, charitable foundation, or other entity that may provide a product or service as a relationship action to one or more contacts 170, as directed by computing system 180 and/or one or more of computing devices 110. In some examples, service provider 161 may be any conceivable service provider, such as a catering service, travel agent, florist, delivery service, a manufacturer, or a professional service providing accounting, legal, or medical services. In some examples, service provider computing system 160 may be capable of delivering or arranging the physical or electronic delivery of a product or other item of value manufactured by service provider 161 or by another entity. In the example of FIG. 1, one or more computing devices connected to network 105, such as computing devices 110 and/or computing system 180, may communicate with service provider computing system 160 over network 105 to access services provided by service provider 161.

One or more financial services computing systems 150 may include devices or systems that may operate to perform functions on behalf of one or more financial services entities 151. Financial services computing system 150 may be implemented through any suitable computing system, such as one or more server computers, mainframes, workstations, cloud computing systems, server farms, server clusters, or any other suitable computing system. Financial services entity 151, which may be a bank, financial institution, financial or wealth advisory firm, or similar entity, may control the operation of financial services computing system 150. Financial services computing system 150 may include capabilities for maintaining funds, transferring funds, managing funds, financial products, or loans, identifying one or more accounts associated with one or more devices or users, and/or performing other functions. In some examples, financial services computing system 150 may represent or include a cloud computing system that provides services to one or more financial advisors, consultants, relationship managers, and/or their customers or clients. In the example of FIG. 1, one or more computing devices connected to network 105, such as computing devices 110 and/or computing system 180, may communicate with financial services computing system 150 over network 105 to access services provided by financial services computing system 150 or financial services entity 151.

One or more computing systems 180 may represent a cloud computing system that provides relationship management services on behalf of one or more relationship managers operating one or more computing devices 110. Computing system 180 may provide, for instance, information about one or more contacts 170 associated with a user of one or more computing devices 110. Computing system 180 may propose one or more relationship actions with respect to one or more contacts 170 of a user of one or more computing devices 110. Computing system 180 may initiate, perform, or cause to be performed one or more relationship actions on behalf of a relationship manager or a user of one or more computing devices 110. Computing system 180 may propose marketing of new products and/or services to one or more contacts 170. Client devices (e.g., one or more of computing devices 110) may communicate with computing system 180 over network 105 to access services provided by computing system 180. In some examples, computing system 180 may host or provide services to one or more of computing devices 110 through one or more modules of computing systems 180.

In some examples, computing system 180 may implement a loyalty reward system or may be part of a loyalty reward system implemented by another entity, such as financial services entity 151. Computing system 180 may maintain a count of loyalty points that reflects, for each of contacts 170, information such as a history of prior product purchases made by each of contacts 170, a history of prior service purchases made by each of contacts 170, and/or an indication of the length of time that each of contacts 170 has maintained a personal or business relationship with a user of one or more computing devices 110.

Computing system 180 may be implemented through any suitable computing system, such as one or more server computers, mainframes, workstations, cloud computing systems, server farms, server clusters, or any other suitable computing system. In some examples, computing system 180 may be fully implemented as hardware in one or more devices or logic elements. Although computing system 180 of FIG. 1 may be stand-alone device, computing system 180 may take many forms, and may be implemented using multiple devices and/or systems. In other examples, computing system 180 may be, or may be part of, any component, device, or system that includes a processor or other suitable computing environment for processing information or executing software instructions and that operates in accordance with one or more aspects of the present disclosure. For instance, computing system 180 may be integrated into and/or implemented as or as part of one or more financial services computing systems 150.

Contacts data store 194 may represent any suitable data structure or storage medium for storing information related to contacts 170 associated with a relationship manager or user of one or more computing devices 110. For instance, information related to contacts 170 may include, for each contact 170, a name, nickname, or former name or nickname, a birthdate, address, employer names, employment history, credit history, financial information, family members, friends, business partners, or other related, affiliated, or otherwise connected people, associated entities (charitable organizations, clubs, corporate entities in which a contact is, was, or has invested), information derived from property records, marriage records, or other governmental records, information derived from social media accounts or other online activity, online communications (e.g., forums, email, press releases, etc.), news reporting, any similar information about family members, friends, or business partners of a contact, and/or any other information that may be of interest to a relationship manager.

Contacts data store 194 may also maintain for each of contacts 170 a list of loyalty points. Contacts data store 194 may maintain, for each of contacts 170, a trust index (as described further below) or information used to calculate a trust index. Computing system 180 may store information about one or more contacts 170 within contacts data store 194 and associate the information with a relationship manager operating one or more of computing devices 110. Computing system 180 may access information stored within contacts data store 194 and use the information stored within contacts data store 194 to construct a search query for one or more information source computing systems 140. Computing system 180 may store information within contacts data store 194 responsive to the initiation and/or completion of the relationship action.

The information stored in contacts data store 194 may be searchable and/or categorized such that one or more modules within computing system 180 may provide an input requesting information from contacts data store 194, and in response to the input, receive information stored within contacts data store 194. Contacts data store 194 may be primarily maintained by computing system 180, and computing system 180 may update contacts data store 194 to include new or supplemental information about one or more contacts 170. Contacts data store 194 may store information for one or more users of computing devices 110. Contacts data store 194 may provide other modules with access to the data stored within contacts data store 194, and/or may analyze the data stored within contacts data store 194 and output such information on behalf of other modules of computing system 180.

In the example of FIG. 1, and in accordance with one or more aspects of the present disclosure, computing device 110A may browse to or interact with computing system 180 over network 105. For example, computing device 110A may detect input that it determines corresponds to a request to interact with or browse to computing system 180. Computing device 110A may send a request over network 105 to computing system 180. Computing system 180 may detect a signal over network 105 and respond by sending information over network 105 to computing device 110A. Computing device 110A may detect a signal over network 105 and determine that the signal corresponds to a web page requesting authentication credentials. Computing device 110A may present the web page at an output device associated with computing device 110A.

Computing system 180 may authenticate the user of computing device 110A. For example, computing device 110A may detect input corresponding to interactions with the web page presented at computing device 110A. In response, computing device 110A may send a signal over network 105. Computing system 180 may detect a signal over network 105 and determine that the signal corresponds to authentication credentials, such as a username and password, entered by a user of computing device 110A. Computing system 180 may determine that the authentication credentials identify and/or authenticate the user of computing device 110A. Computing system 180 and computing device 110A may further communicate, and establish a session for the authenticated user at computing device 110A.

Computing system 180 may maintain contact information for a number of users of computing devices 110, including, for example, a user of computing device 110A. For example, a user of computing device 110A may be a relationship manager that keeps track of and/or attempts to maintain productive relationships with a number of people or contacts 170. Contacts 170 may include customers, clients, business partners, or other people that the relationship manager works with to further business, personal, charitable or other interests. In the example of FIG. 1, computing system 180 may provide organizational and other services to the relationship manager operating computing device 110A. Computing system 180 may also provide similar services to one or more other relationship managers that may be operating other computing devices 110.

One or more computing devices 110 may upload to computing system 180 information about contacts maintained by each respective user of computing devices 110. For example, computing device 110A may output a signal over network 105. Computing system 180 may detect a signal over network 105 and determine that the signal corresponds to a communication from computing device 110A. Computing system 180 may further determine that the signal includes information items about one or more contacts 170. In some examples, such information items may be derived from user input detected at computing device 110A (e.g., a user of computing device 110A typing at a keyboard). In other examples, computing system 180 may determine that the signal includes information identifying or providing access to a data store that includes information about one or more contacts 170. In such an example, computing system 180 may access the data store and determine information items about one or more contacts 170. The data store may include a file, set of files, database, data store, network address, authentication credentials for a user account, or any other information that may identify a storage location for information items associated with one or more personal or other contacts of a user of computing device 110A.

Computing system 180 may store the information about one or more contacts 170 within contacts data store 194 and associate the information with an appropriate relationship manager. In some examples, the appropriate relationship manager corresponds to an authenticated user of a computing device, such as computing device 110A. Similarly, computing system 180 may store information received from other computing devices 110, and computing system 180 associate, within contacts data store 194, the information received from each computing devices 110 with each respective relationship manager or authenticated user. The items of information about contacts 170 may include information of any nature, including the information items of the type described in connection with contacts data store 194.

Computing system 180 may analyze the information stored within contacts data store 194 and determine dates and events of interest associated with one or more contacts 170. For instance, computing system 180 may determine that on a specific day within the near future, contact 170A will celebrate his 30th birthday. In another example, computing system 180 may determine that on a specific day within the near future, contact 170B will have been a client of the user of computing device 110A (e.g., a relationship manager and/or financial advisor) for exactly three years. In another example, computing system 180 may determine that on a specific day within the near future, the daughter of contact 170C will graduate from high school. In yet another example, contact 170D will have spent eight years at her current employer. Many other examples are possible, and the examples provided herein are illustrative.

Computing system 180 may periodically, occasionally, and/or continually monitor or query one or more information source computing systems 140 for further information about one or more contacts 170. For example, computing system 180 may access information stored within contacts data store 194 and use the information stored within contacts data store 194 to construct a search query for one or more information source computing systems 140. Computing system 180 may include in the query information about one or more contacts 170, and such information may include names, addresses, business names, or other items of information stored within contacts data store 194.

In one example, computing system 180 may query one or more information source computing system 140, which may be or include a local news web site, for information about “Benjamin Smith.” In the example of FIG. 1, Benjamin Smith may be the person corresponding to contact 170B. Computing system 180 may construct a query that includes the text “Benjamin Smith.” Computing system 180 may transmit the query over network 105 to information source computing system 140. Information source computing system 140 may identify, in response to such a query, one or more news articles that relate in some way to “Benjamin Smith.” For example, information source computing system 140 may identify articles that may be about Benjamin Smith, may mention or quote Benjamin Smith, may be about the entity that employs Benjamin Smith, may be about the entity that employs a family member of Benjamin Smith, or may be about other information relating in some way to Benjamin Smith. In other examples, computing system 180 may construct a query that may include the name of one or more of Benjamin Smith's family members, friends, business partners, or other related, affiliated, or otherwise connected people. In other examples, computing system 180 may construct a query that may include the name of Benjamin Smith's employer, or another entity associated with Benjamin Smith (e.g., a charitable organization, a club, or a corporate entity in which a Benjamin Smith is an investor). Although described as a local news web site, in other examples, information source computing system 140 may be a web site or other information source that provides access to property records, legal records, and/or government records, and computing system 180 may similarly interact with such computing systems to derive relevant information about Benjamin Smith. Further, computing system 180 may query one or more information source computing systems 140 for information about other contacts for which contacts data store 194 maintains a record, such as contact 170B, contact 170C, contact 170D, or any of the other contacts 170.

In some examples, computing system 180 may engage in data scraping techniques to cull information about such contacts from sources on the network, such as information source computing system 140. Such techniques may include web scraping, web harvesting, web data extraction, or another technique that may include gathering data from the content of web pages. Such techniques may include gathering information from other sources on network 105 beyond web sites, such as any data store, server, information repository, or other resource that may be available on network 105.

In other examples, rather than or in addition to engaging in data scraping techniques, computing system 180 may receive a feed of information from one or more information source computing systems 140. In such an example, computing system 180 may periodically, occasionally, and/or continually parse the information received through the feed, and identify information that is relevant to one or more contacts 170. Computing system 180 may update contacts data store 194 to include the identified information in each relevant record associated with one or more relevant contacts 170.

Computing device 110A may present information about one or more contacts 170. For example, computing device 110A may detect input that it determines corresponds to a request to interact with or browse to computing system 180. Computing device 110A may send a request over network 105 to computing system 180. Computing system 180 may detect a signal and respond by communicating with computing device 110A over network 105. Computing device 110A and computing system 180 may further communicate, and 180 may determine that the user of computing device 110A is an authenticated user. Computing system 180 may send a signal over network 105 to computing device 110A that includes information about one or more contacts 170 associated with the user of computing device 110A. Computing device 110A may detect a signal over network 105 and determine that the signal corresponds to information about one or more contacts 170. Computing device 110A may, based on the information received over network 105 from computing system 180, construct user interface 131. Computing device 110A present user interface 131 at an output device (e.g., a display) associated with computing device 110A.

In some examples, user interface 131 may include news feed 141. In some examples, news feed 141 may present information about one or more contacts 170 that are associated with the user of computing device 110A within contacts data store 194. News feed 141 may include information indicating that one or more contacts 170 has an upcoming anniversary, birthday, or important event. News feed 141 may alternatively, or in addition, include information about a news event or other item of information associated with or related in some way to one or more contacts 170. In some examples, news feed 141 may include information that computing system 180 has determined by querying one or more information source computing systems 140. News feed 141 may also include one or more prompts inviting the user of computing device 110A to approve a relationship action for one or more contacts 170 included within the newsfeed within user interface 131. As further described below, a relationship action may involve a user of one or more computing devices 110 causing or arranging for a service or item of value to be provided to one or more contacts 170.

Computing system 180 may perform one or more relationship actions proposed within news feed 141. For example, computing device 110A may detect input interacting with news feed 141. Computing device 110A may output a signal over network 105. Computing system 180 may detect a signal over network 105 and determine that the signal corresponds to input by a user of computing device 110A interacting with a prompt inviting the user of computing device 110A to approve a proposed relationship action. Computing system 180 may further determine that the input corresponds to approval of the proposed relationship action. Responsive to such input, computing system 180 may initiate or perform the proposed relationship action.

In some examples, the relationship action may involve computing system 180 causing one or more service providers 160 to provide a service, an item of value, or other benefit to one or more contacts 170. In some examples, the service, item of value, or other benefit may be funded at least in part, through loyalty points accrued by one or more contacts 170. To initiate or perform a relationship action, computing system 180 may output a signal over network 105. Service provider computing system 160 may detect the signal and determine that the signal corresponds to a request to perform a service or provide an item of value to one or more contacts 170. Service provider computing system 160 may, in response to the request, perform the service, provide the item of value, or otherwise cause service provider 161 to respond to the request. For instance, service provider 161 and/or service provider computing system 160 may arrange for physical or electronic delivery of a communication, gift, token of appreciation, or other item that one or more contacts 170 may appreciate or consider valuable or useful.

After initiating, delivering, or otherwise completing the relationship action, computing system 180 may receive a confirmation. For example, for relationship actions performed by service provider computing system 160, service provider computing system 160 may communicate a signal over network 105. Computing system 180 may detect a signal, and determine that the signal corresponds to an indication, from service provider computing system 160, that the requested relationship action has been initiated, delivered, and/or completed. Computing system 180 may store information within contacts data store 194 responsive to the initiation, delivery, and/or completion of a task corresponding to the relationship action.

In another example, the relationship action may involve financial services entity 151 (rather than one or more service providers 161) providing a service, item of value, or other benefit to one or more contacts 170. In some examples, financial services entity 151 may employ or may be otherwise affiliated with the authenticated user of computing device 110. In other words, computing device 110 may be operated by a relationship manager (e.g., a financial advisor or a wealth advisor) who is associated with, affiliated with, and/or employed by financial services entity 151. In such an example, computing system 180, which may also be operated or controlled by financial services entity 151, may output a signal over network 105. Financial services computing system 150 may detect the signal and determine that the signal corresponds to a request to perform a service or provide some item of value to one or more contacts 170. Financial services computing system 150 may, in response to the signal, perform a service, which may include modifying the terms associated with a financial product or financial relationship that financial services entity 151 has with one or more contacts 170. For instance, financial services computing system 150 may modify the terms of a loan to which both contact 170A and financial services entity 151 are parties. In one example, financial services computing system 150 may lower the interest rate on a loan, waive a payment requirement, or adjust the length of the loan. After completing the relationship action, financial services computing system 150 may communicate a signal over network 105. Computing system 180 may detect a signal, and determine that the signal corresponds to an indication, from financial services computing system 150, that a relationship action has been initiated or completed for contact 170A. Computing system 180 may store information within contacts data store 194 responsive to the initiation and/or completion of the relationship action.

In other examples, the relationship action may involve computing system 180 causing service provider 161, financial services entity 151, and/or another entity to make a charitable donation, or to provide a service, an item of value, or other benefit to a charity, to a charitable organization, or to any other person or entity on behalf of one or more contacts 170. In one such example, financial services entity 151 may provide a charitable donation to a charity favored by one or more contacts 170. In some examples, some or all of the donation may funded through loyalty points accrued by one or more contacts 170.

Computing system 180 may maintain a trust index that represents the expected strength of the relationship between a relationship manager and one or more contacts 170. For example, each time a relationship action is performed by computing system 180, computing system 180 may store information reflecting the value provided to one or more contacts 170. As computing system 180 performs relationship actions for a given contact, the relationship between the relationship manager (e.g., the user operating computing device 110A) and the contact might be expected to become stronger. Multiple relationship actions performed on behalf of a relationship manager for a particular contact, for example, may tend to increase a level of trust between that relationship manager and the contact. In some examples, a contact may tend to have a predictably higher level of trust in the relationship manager, to the extent that the relationship manager is perceived to be providing value to the contact, attending to the well-being of the contact, and/or furnishing timely advice. Accordingly, computing system 180 may, based on a history of relationship actions, determine a score or a rating that reflects the trust the contact might be expected to have in the relationship manager. In some examples, such a score or rating may be considered a trust index that may be used to gauge a contact's candidacy and/or receptiveness to receiving promotional materials, marketing materials, communications pursuant to a marketing agenda, and/or other commercial communications about new, updated, modified, or other products and/or services.

A number of operations are described herein as being at least partially performed by computing system 180 (e.g., monitoring information sources for information about one or more contacts, determining proposed relationship actions, outputting information sufficient to generate user interfaces, receiving authorization for and performing proposed relationship actions, and/or other operations). In other examples, some or all of such operations may be performed or initiated by one or more other computing devices, such as one or more computing devices 110.

Throughout the disclosure, examples may be described where a computing device and/or a computing system may research information about one or more contacts and use such information to perform a relationship action. Further, in some cases, a computing system may determine a trust index that may be used to determine receptiveness to marketing new products or services. In some implementations, such practices may be only performed if the computing system receives permission from such contacts to carry out such practices. For example, in situations described or discussed in this disclosure, before a computing system (e.g., computing system 180) may collect or make use of information about a contact, the contact may be provided with an opportunity to provide input to control how, when, and/or whether computing system 180 can collect and make use of the contact's personal information (e.g., personal information, information about family members, friends, business partners, investments, employers, interest profiles, or other information, information from one or more information source computing systems 140). In addition, in some cases, certain data may be treated in one or more ways before it is stored or used by any computing device, so that personally-identifiable information is removed. For example, a user's identity may be treated so that no personally identifiable information can be determined about the user, or a user's geographic location may be generalized where location information is obtained (such as to a city, ZIP code, or state level), so that an exact location of a user cannot be determined. Thus, the user may have control over how information is collected about the user and used by all computing devices and/or systems.

By automatically researching information about contacts 170 associated with users of computing devices 110, computing system 180 may help such users keep informed about events occurring with contacts 170. By helping users keep informed, computing system 180 may enable users of computing devices 110 spend less time and effort using one or more computing devices 110 to find, research, or search for information about one or more contacts 170. As a result, computing devices 110 may perform less computing operations performing research or engaging in marketing communications on behalf of users of computing devices 110. By performing less computing operations, computing devices 110 may consume less electrical power. Therefore, aspects of this disclosure may improve the function of system 100 and/or computing device 110 because keeping users informed about events occurring with contacts 170 may have the effect of consuming less electrical power.

Further, by automatically researching information about contacts 170 associated with users of computing devices 110, computing system 180 may help such users improve relations with contacts 170. As a result of improving relations with contacts 170, users of computing devices 110 may identify opportunities to engage in mutually beneficial business with one or more contacts 170, and/or increase mutually beneficial personal or business interactions with contacts 170.

By proposing and/or executing relationship actions for contacts 170 on behalf of users of computing devices 110, users of computing devices 110 may avoid losing touch with contacts 170, and may establish and maintain a loyal personal and/or business relationship with contacts 170. By establishing and maintaining such relationships, users of computing devices 110 may avoid, to some extent, having to use computing devices 110 or other computing devices to engage in marketing communications with contacts 170, since maintaining a high trust index with contacts 170 may render such efforts unnecessary. By engaging in less marketing computing communications, computing devices 110 may perform less computing operations and use less network resources. As a result of performing less computing operations, computing devices 110 may consume less electrical power. As a result of using less network resources, computing devices 110 may contribute less to network congestion.

Further, where users of computing devices 110 are able to maintain a loyal personal, business, and/or trust relationship with contacts 170, contacts 170 may be more trusting of proposed products and/or services that users of computing devices 110 may propose to contacts 170. As a result, one or more contacts 170 may be less inclined to use computing resources (e.g., contact computing device 171) to carefully research products and/or services proposed by users of computing devices 110 prior to purchasing such products and/or services. Accordingly, less computing operations may be used by contacts 170 performing such research (e.g., through contact computing device 171), and as a result, less network operations and less electrical power may be consumed.

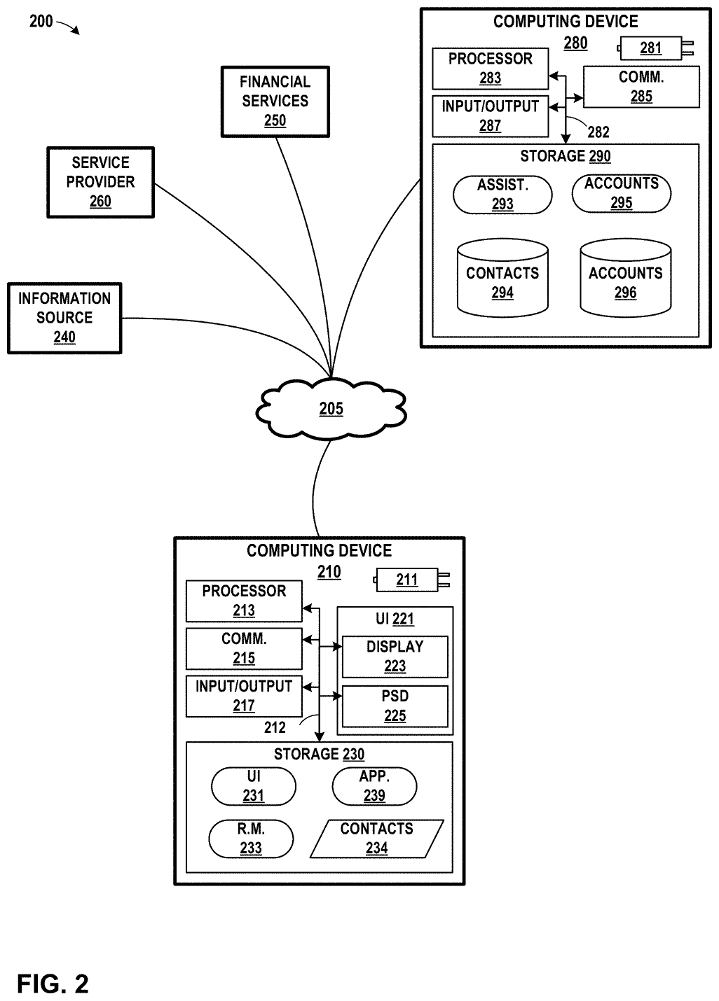

FIG. 2 is a block diagram illustrating another example system for identifying events associated with personal or business contacts and performing relationship actions with respect to those contacts, in accordance with one or more aspects of the present disclosure. One or more aspects of FIG. 2 may be described herein within the context of system 100 of FIG. 1. System 200 of FIG. 2 may be described as an example or alternate implementation of system 100 of FIG. 1. Other example or alternate implementations of system 200 may be appropriate in other instances. Such implementations may include a subset of the devices and/or components included in the example of FIG. 2 and/or may include additional devices and/or components not shown in FIG. 2.

System 200 may be implemented in a number of different ways. In some examples, one or more devices of system 200 that are illustrated as separate devices may be implemented as a single device; one or more components of system 200 that are illustrated as separate components may be implemented as a single component. Also, in some examples, one or more devices of system 200 that are illustrated as a single device may be implemented as multiple devices; one or more components of system 200 that are illustrated as a single component may be implemented as multiple components. Further, one or more devices or components of system 200 that are illustrated in FIG. 2 may be implemented as part of another device or component not shown in FIG. 2.

In the example of FIG. 2, system 200 includes network 205, one or more computing systems 280, and one or more computing devices 210. FIG. 2 may further include one or more information source computing systems 240, one or more service provider computing systems 260 and one or more financial services computing systems 250. Network 205 corresponds to network 105 of FIG. 1, and may be implemented in a manner consistent with or different than the description of network 105 provided in connection with FIG. 1. Similarly, information source computing system 240 corresponds to information source computing system 140, service provider computing system 260 corresponds to service provider computing system 160, and financial services computing system 250 corresponds to financial services computing system 150; in each case, the respective systems or set of systems in FIG. 2 may be implemented in a manner consistent with or different than the corresponding systems described in connection with FIG. 1.

Computing device 210 corresponds to one of computing devices 110 of FIG. 1, may be implemented in a manner consistent with or different than the description of one or more computing devices 110 provided in connection with FIG. 1. In some examples, computing device 210 of FIG. 2 may include more capabilities than those described in connection with FIG. 1, less capabilities than those described in connection with FIG. 1, or capabilities different than those described in connection with FIG. 1.

In the example of FIG. 2, computing device 210 includes power source 211, one or more processors 213, one or more communication (comm.) units 215, one or more input/output devices 217, one or more user interface (UI) devices 221, and one or more storage devices 230. In the example of FIG. 2, user interface device 221 may include display 223 and presence-sensitive device (PSD) 225. Storage devices 230 may include user interface (UI) module 231, relationship management (R.M.) module 233, contacts information 234, and application (app.) modules 239. One or more of the devices, modules, storage areas, or other components of computing device 210 may be interconnected to enable inter-component communications (physically, communicatively, and/or operatively). In some examples, such connectivity may be provided by through communication channels (e.g., communication channels 212), a system bus, a network connection, an inter-process communication data structure, or any other method for communicating data.

Power source 211 may provide power to one or more components of computing device 210. Power source 211 may be a battery. In other examples, power source 211 may receive power from the primary alternative current (AC) power supply in a building, home, or other location. In still further examples, computing device 210 and/or power source 211 may receive power from another source. One or more of the devices or components illustrated within computing device 210 may be connected to power source 211, and/or may receive power from power source 211. Power source 211 may have intelligent power management or consumption capabilities, and may such features may be controlled, accessed, or adjusted by one or more modules of computing device 210 and/or by one or more processors 213 to intelligently consume, allocate, supply, or otherwise manage power.

One or more processors 213 of computing device 210 may implement functionality and/or execute instructions associated with computing device 210 or associated with one or more modules illustrated herein and/or described below. Examples of processors 213 include microprocessors, application processors, display controllers, auxiliary processors, one or more sensor hubs, and any other hardware configured to function as a processor, a processing unit, or a processing device. Computing device 210 may use one or more processors 213 to perform operations in accordance with one or more aspects of the present disclosure using software, hardware, firmware, or a mixture of hardware, software, and firmware residing in and/or executing at computing device 210.

One or more communication units 215 of computing device 210 may communicate with devices external to computing device 210 by transmitting and/or receiving data, and may operate, in some respects, as both an input device and an output device. In some examples, communication unit 215 may communicate with other devices over a network. In other examples, communication unit 215 may send and/or receive radio signals on a radio network such as a cellular radio network. In other examples, communication unit 215 of computing device 210 may transmit and/or receive satellite signals on a satellite network such as a Global Positioning System (GPS) network. Examples of communication units 215 include a network interface card (e.g. such as an Ethernet card), an optical transceiver, a radio frequency transceiver, a GPS receiver, or any other type of device that can send and/or receive information. Other examples of communication units 215 may include devices capable of communicating over Bluetooth®, GPS, NFC, ZigBee, and cellular networks (e.g., 3G, 4G, 5G), and Wi-Fi® radios found in mobile devices as well as Universal Serial Bus (USB) controllers and the like. Such communications may adhere to, implement, or abide by appropriate protocols, including Transmission Control Protocol/Internet Protocol (TCP/IP), Ethernet, Bluetooth, NFC, or other technologies or protocols.

One or more input devices 217 may represent any input or output devices of computing device 210 not otherwise separately described herein. One or more input devices 217 may generate, receive, and/or process input from any type of device capable of detecting input from a human or machine. For example, one or more input devices 217 may generate, receive, and/or process input in the form of physical, audio, image, and/or visual input (e.g., keyboard, microphone, camera). One or more input devices 217 may generate, present, and/or process output through any type of device capable of producing output. For example, one or more input devices 217 may generate, present, and/or process output in the form of tactile, audio, visual, and/or video output (e.g., haptic response, sound, flash of light, and/or images). Some devices may serve as input devices, some devices may serve as output devices, and some devices may serve as both input and output devices.

User interface device 221 may function as an input and/or output device or set of input/output devices for computing device 210, and may be implemented using various devices, components, and/or technologies. User interface device 221 may include a keyboard, pointing device, and display. User interface device 221 may alternatively, or in addition, include presence-sensitive input panel technologies, microphone technologies, voice activation and/or recognition technologies, cameras, sensor technologies (e.g., infrared, image, location, motion, accelerometer, gyrometer, magnetometer), or other input device technology for use in receiving user input. User interface device 221 may include various speaker technologies, various displays or display technologies, haptic feedback technologies, tactile feedback technologies, light emitting technologies, or other output device technologies for use in outputting information to a user.

In the example of FIG. 2, user interface device 221 includes one or more displays 223 and one or more presence-sensitive devices 225. Although certain components associated with computing device 210 are described or illustrated in FIG. 1 as being implemented within user interface device 221, in other examples, such components could be implemented external to user interface device 221, and other components could be implemented within user interface device 221. Further, while illustrated as an internal component of computing device 210, user interface device 221 may also represent an external or partially external component that shares a data path with computing device 210 for transmitting and/or receiving input and output. For instance, in some examples, user interface device 221 represents a built-in component of computing device 210 located within and physically connected to the external packaging of computing device 210 (e.g., a screen on a mobile phone or tablet). In other examples, user interface device 221 represents an external component of computing device 210 located outside and physically separated from the packaging or housing of computing device 210 (e.g., a monitor, a projector, etc. that shares a wired and/or wireless data path with computing device 210). In still other examples, one or more components of user interface device 221 may be built-in components of computing device 210, and one or more components of user interface device 221 may be external components of computing device 210 (e.g., some components of user interface device 221 may be internal, and others may be external). Further, one or more components of user interface device 221 may be integrated together, so that one component is or appears to be a built-in component of another.

For instance, display 223 may integrated with presence-sensitive device 225, so that user interface device 221 includes or operates as a touch-sensitive or presence-sensitive display screen. In such an implementation, user interface device 221 may receive indications of tactile input by detecting one or more gestures from a user (e.g., the user touching or pointing to one or more locations of display 223 with a finger or a stylus pen). User interface device 221 may present output to a user as a graphical user interface at display 223. For example, user interface device 221 may present various user interfaces related to functions provided by one or more modules of computing device 210 or another feature of a computing platform, operating system, application, and/or service executing at or accessible from computing device 210 (e.g., an electronic message application, Internet browser application, a mobile or desktop operating system, etc.).

One or more displays 223 may refer to any appropriate type of display device, such as a display associated with any type of computing device, such as a desktop computer, laptop computer, tablet, mobile phone, watch, or any other type of wearable, non-wearable, mobile, or non-mobile computing device. Display 223 may function as one or more output (e.g., display) devices using technologies including liquid crystal displays (LCD), dot matrix displays, light emitting diode (LED) displays, organic light-emitting diode (OLED) displays, e-ink, or similar monochrome or color displays capable of generating tactile, audio, and/or visual output. Display 223 may include a cathode ray tube (CRT) monitor, liquid crystal display (LCD), Light-Emitting Diode (LED) display, or any other type of display device.

Display 223 may output information to a user in the form of a user interface (e.g., as shown in FIG. 1), which may be associated with functionality provided by computing device 210. Such user interfaces may be associated with computing platforms, operating systems, applications, and/or services executing at or accessible from computing device 210 (e.g., financial advisor applications, wealth management applications, relationship management applications, loan management or origination applications, banking applications, electronic message applications, chat applications, Internet browser applications, mobile or desktop operating systems, social media applications, electronic games, and other types of applications). For example, display 223 may present one or more user interfaces which are graphical user interfaces of an application executing at computing device 210 including various graphical elements displayed at various locations of display 223.

One or more presence-sensitive devices 225 may serve as an input device. In some examples, presence-sensitive device 225 may also provide output to a user using tactile, haptic, audio, visual, or video stimuli. For example, presence-sensitive device 225 may be integrated into a display component (e.g., display 223), so that presence-sensitive device 225 serves as a touch-sensitive display screen. In such an example, presence-sensitive device 225 may determine the location of that portion of the surface of display 223 selected by a stylus or a user's finger using capacitive, inductive, and/or optical recognition techniques. Based on such input, presence-sensitive device 225 may output or update a graphical user interface presented at display 223.

One or more storage devices 230 within computing device 210 may store information for processing during operation of computing device 210. Storage devices 230 may store program instructions and/or data associated with one or more of the modules described in accordance with one or more aspects of this disclosure. One or more processors 213 and one or more storage devices 230 may provide an operating environment or platform for such modules, which may be implemented as software, but may in some examples include any combination of hardware, firmware, and software. One or more processors 213 may execute instructions and one or more storage devices 230 may store instructions and/or data of one or more modules. The combination of processors 213 and storage devices 230 may retrieve, store, and/or execute the instructions and/or data of one or more applications, modules, or software. Processors 213 and/or storage devices 230 may also be operably coupled to one or more other software and/or hardware components, including, but not limited to, one or more of the components of computing device 210 and/or one or more devices or systems illustrated as being connected to computing device 210.

In some examples, one or more storage devices 230 are temporary memories, meaning that a primary purpose of the one or more storage devices is not long-term storage. Storage devices 230 of computing device 210 may be configured for short-term storage of information as volatile memory and therefore not retain stored contents if deactivated. Examples of volatile memories include random access memories (RAM), dynamic random access memories (DRAM), static random access memories (SRAM), and other forms of volatile memories known in the art. Storage devices 230, in some examples, also include one or more computer-readable storage media. Storage devices 230 may be configured to store larger amounts of information than volatile memory. Storage devices 230 may further be configured for long-term storage of information as non-volatile memory space and retain information after activate/off cycles. Examples of non-volatile memories include magnetic hard disks, optical discs, floppy disks, Flash memories, or forms of electrically programmable memories (EPROM) or electrically erasable and programmable (EEPROM) memories.

User interface module 231 may manage user interactions with user interface device 221 and other components of computing device 210. User interface module 231 may cause user interface device 221 to output various user interfaces for display or presentation or otherwise, as a user of computing device 210 views, hears, or otherwise senses output and/or provides input at user interface device 221. User interface device 221 may detect input, and may output to user interface module 231 one or more indications of input as a user of computing device 210 interacts with a user interface presented at user interface device 221. User interface module 231 and user interface device 221 may interpret inputs detected at user interface device 221 and may relay information about the inputs detected at user interface device 221 to one or more associated platforms, operating systems, applications, and/or services executing at computing device 210 to cause computing device 210 to perform one or more functions. User interface module 231 may receive information and instructions from a platform, operating system, application, and/or service executing at computing device 210 and/or one or more remote computing systems. In addition, user interface module 231 may act as an intermediary between a platform, operating system, application, and/or service executing at computing device 210 and various output devices of computing device 210 (e.g., speakers, LED indicators, audio or electrostatic haptic output devices, light emitting technologies, displays, etc.) to produce output (e.g., a graphic, a flash of light, a sound, a haptic response, etc.).

Relationship management module 233 may perform functions relating to presenting, at computing device 210, a user interface (e.g., user interface 331) that includes a listing or a news feed of information about one or more contacts for a user of computing device 210, and that may include proposed relationship actions relating to one or more contacts. Relationship management module 233 may receive information from user interface module 231 and determine that indications of input correspond to interactions, by a user of computing device 210 with a user interface presented at display 223. Relationship management module 233 may create, update, and maintain contact information 234. Relationship management module 233 may receive, via communication unit 215 over network 205, information sufficient to create a user interface, such as user interface module 231. Relationship management module 233 may cause communication unit 215 to output over network 205, to computing system 280, information about interactions with a user interface presented at display 223. Relationship management module 233 may interact with and/or operate in conjunction with one or more modules, which may include relationship management module 233 receiving information from and/or outputting information to one or more other modules of computing device 210. Although relationship management module 233 may be described in connection with FIG. 2 as performing certain operations relating to presentation of and interaction with user interfaces (e.g., 331), display 223 may perform other operations. Further, although described as a module, functions performed by relationship management module 233 could be performed by a hardware device or one implemented primarily or partially through hardware. In some examples, relationship management module 233 may be or may include a web browser, and may function by rendering content received from one or more devices over network 105. In such an example, one or more functions, operations, or other actions attributed to relationship management module 233 may be alternatively attributed to other modules, components, or devices (e.g., devices shown in FIG. 1 or FIG. 2).

Contact information 234 may include stored information received as input through user interface device 221 about one or more contacts. In some examples, contact information 234 may include information of the type stored in contacts data store 294. Contact information 234 may be created, updated, and/or maintained by relationship management module 233. User interface device 221 may detect input that relationship management module 233 determines corresponds to input entered by a user of computing device 210 about one or more contacts. Such input may correspond to notes taken by a user of computing device 210, a voice recording or transcript of a conversation with one or more contacts, or other information collected by or created by a user of computing device 210. In some examples, relationship management module 233 may access information stored within contact information 234 and transmit such information, over network 205, for storage and/or analysis at contacts data store 294.

One or more application modules 239 may represent some or all of the other various individual applications and/or services executing at and accessible from computing device 210. A user of computing device 210 may interact with a graphical user interface associated with one or more application modules 239 to cause computing device 210 to perform a function. Numerous examples of application modules 239 may exist and may include web browsing, search, communication, and shopping applications, and any and all other applications that may execute at computing device 210.

Computing device 280 corresponds to computing system 180 of FIG. 1, may be implemented in a manner consistent with or different than the description of computing system 180 provided in connection with FIG. 1. In some examples, computing system 280 of FIG. 2 may include more capabilities than those described in connection with FIG. 1, less capabilities than those described in connection with FIG. 1, or capabilities different than those described in connection with FIG. 1.

In the example of FIG. 2, computing system 280 may include power source 281, one or more processors 283, one or more communication units 285, one or more input/output devices 287, and one or more storage devices 290. Storage devices 290 may include relationship assistant (assist.) module 293, contacts data store 294, accounts module 295, and relationship manager accounts data store 296. One or more of the devices, modules, storage areas, or other components of computing system 280 may be interconnected to enable inter-component communications (physically, communicatively, and/or operatively). In some examples, such connectivity may be provided by through communication channels (e.g., communication channels 282), a system bus, a network connection, an inter-process communication data structure, or any other method for communicating data.

Power source 281 may provide power to one or more components of computing system 280. Power source 281 may receive power from the primary alternative current (AC) power supply in a building, home, or other location. In other examples, power source 281 may be a battery. In still further examples, computing system 280 and/or power source 281 may receive power from another source. One or more of the devices or components illustrated within computing system 280 may be connected to power source 281, and/or may receive power from power source 281. Power source 281 may have intelligent power management or consumption capabilities, and such features may be controlled, accessed, or adjusted by one or more modules of computing system 280 and/or by one or more processors 213 to intelligently consume, allocate, supply, or otherwise manage power.

One or more processors 283 of computing system 280 may implement functionality and/or execute instructions associated with computing system 280 or associated with one or more modules illustrated herein and/or described below. Examples of processors 283 may include any of the processors described above in connection with computing device 210. Computing system 280 may use one or more processors 283 to perform operations in accordance with one or more aspects of the present disclosure using software, hardware, firmware, or a mixture of hardware, software, and firmware residing in and/or executing at computing system 280.

One or more communication units 285 of computing system 280 may communicate with devices external to computing system 280 by transmitting and/or receiving data, and may operate, in some respects, as both an input device and an output device. In some examples, communication unit 285 may communicate with other devices over a network. In other examples, communication units 285 may send and/or receive radio signals on a radio network such as a cellular radio network. In other examples, communication units 285 of computing system 280 may transmit and/or receive satellite signals on a satellite network such as a Global Positioning System (GPS) network.

One or more input/output devices 287 may represent any input or output devices of computing system 280 not otherwise separately described herein. One or more input/output devices 287 may generate, receive, and/or process input from any type of device capable of detecting input from a human or machine. For example, one or more input/output devices 287 may generate, receive, and/or process input in the form of physical, audio, image, and/or visual input (e.g., keyboard, microphone, camera). One or more input/output devices 287 may generate, present, and/or process output through any type of device capable of producing output. For example, one or more input/output devices 287 may generate, present, and/or process output in the form of tactile, audio, visual, and/or video output (e.g., haptic response, sound, flash of light, and/or images). Some devices may serve as input devices, some devices may serve as output devices, and some devices may serve as both input and output devices.

One or more storage devices 290 within computing system 280 may store information for processing during operation of computing system 280. Storage devices 290 may store program instructions and/or data associated with one or more of the modules described in accordance with one or more aspects of this disclosure. One or more processors 283 and one or more storage devices 290 may provide an operating environment or platform for such modules, which may be implemented as software, but may in some examples include any combination of hardware, firmware, and software. One or more processors 283 may execute instructions and one or more storage devices 290 may store instructions and/or data of one or more modules. The combination of processors 283 and storage devices 290 may retrieve, store, and/or execute the instructions and/or data of one or more applications, modules, or software. Processors 283 and/or storage devices 290 may also be operably coupled to one or more other software and/or hardware components, including, but not limited to, one or more of the components of computing system 280 and/or one or more devices or systems illustrated as being connected to computing system 280. In some examples, one or more storage devices 290 may be implemented in the manner described in connection with storage devices 230 of computing device 210.

Relationship assistant module 293 may perform functions relating to researching and/or identifying events associated with contacts stored within contacts data store 294 and proposing and/or executing relationship actions on behalf of one or more relationship managers operating computing device 210. Relationship assistant module 293 may access data within contacts data store 294 and determine dates of interest (birthdays, anniversaries, etc.) for one or more contacts stored within contacts data store 294. Relationship assistant module 293 may construct one or more search queries to identify information about one or more contacts included within contacts data store 294. Relationship assistant module 293 may perform research about one or more contacts, such as by executing or causing the execution of the search queries. Relationship assistant module 293 may analyze the results of the research and update contacts data store 294 with information derived from the results. Relationship assistant module 293 may access information in contacts data store 294 and select, for presentation at computing device 210, information about contacts associated with the user of computing device 210. Relationship assistant module 293 may propose a relationship action to be performed for one or more contacts. Relationship management module 233 may perform a relationship action or cause the performance of a relationship action on behalf of one or more contacts associated with a user of computing device 210. Relationship assistant module 293 may update contacts data store 294 and/or relationship manager accounts data store 296 to indicate that relationship manager 310 has expressed an opinion of information included within a user interface presented at computing device 210. Relationship assistant module 293 may learn preferences expressed by a user of computing device 210, and use such preferences to shape or tailor information presented at computing device 210. Relationship assistant module 293 may interact with and/or operate in conjunction with one or more modules of computing system 280.

In some examples, relationship assistant module 293 may be integrated into a portal, software application, or computer-based tool set furnished by a financial institution or financial services entity for use in providing financial or wealth management advice. In some examples, such a portal, software application, or computer-based tool set may be provided to one or more financial advisors, wealth management advisors, bankers, relationship managers, and/or other users of computing device 210 for use in performing services on behalf of such a financial institution or financial services entity.

Contacts data store 294 may represent any suitable data structure or storage medium for storing information related to contacts associated with a user of computing device 210. Contacts data store 294 may be similar to and/or may include information that is the same or similar to the information stored within contacts data store 194 of FIG. 1. Relationship assistant module 293 may access information stored within contacts data store 294 and use the information stored within contacts data store 294 to construct a search query for one or more information source computing systems 240. Relationship assistant module 293 may store information within contacts data store 294 responsive to the initiation and/or completion of the relationship action. The information stored in contacts data store 294 may be searchable and/or categorized such that one or more modules within computing system 280 may provide an input requesting information from contacts data store 294, and in response to the input, receive information stored within contacts data store 294. Contacts data store 294 may be primarily maintained by relationship assistant module 293, and relationship assistant module 293 may update contacts data store 294 to include new or updated information. Contacts data store 294 may provide other modules with access to the data stored within contacts data store 294, and/or may analyze the data stored within contacts data store 294 and output such information on behalf of other modules of computing system 280.

Accounts module 295 may perform functions relating to maintaining account information and/or authenticating a user of one or more client devices (e.g., computing device 210) and establishing a session with such devices. In some examples, a user of computing device 210 may be a relationship manager. Accounts module 295 may receive authentication credentials from such a user, and accounts module 295 may determine whether the user operating the client device is an authenticated user. Accounts module 295 may cause computing system 280 to communicate with one or more client devices over network 205. Accounts module 295 may interact with and/or operate in conjunction with one or more modules of computing system 280.

Relationship manager accounts data store 296 may represent any suitable storage medium for storing information related to relationship manager user accounts (usernames, passwords, account numbers, other authentication information). Accounts module 295 may access account information in relationship manager accounts data store 296 and determine that the user of computing device 210 is an authenticated user associated with one or more accounts within relationship manager accounts data store 296. Relationship manager accounts data store 296 may store account information for one or more users of computing device 210 or similar devices. Relationship manager accounts data store 296 may be primarily maintained by accounts module 295.

Modules illustrated in FIG. 2 (e.g., user interface module 231, relationship management module 233, application modules 239, relationship assistant module 293, and accounts module 295) and/or illustrated or described elsewhere in this disclosure may perform operations described using software, hardware, firmware, or a mixture of hardware, software, and firmware residing in and/or executing at one or more computing devices. For example, a computing device may execute one or more of such modules with multiple processors or multiple devices. A computing device may execute one or more of such modules as a virtual machine executing on underlying hardware. One or more of such modules may execute as one or more services of an operating system or computing platform. One or more of such modules may execute as one or more executable programs at an application layer of a computing platform. In other examples, functionality provided by a module could be implemented by a dedicated hardware device. Although certain modules, data stores, components, programs, executables, data items, functional units, and/or other items included within one or more storage devices may be illustrated separately, one or more of such items could be combined and operate as a single module, component, program, executable, data item, or functional unit. For example, one or more modules or data stores may be combined or partially combined so that they operate or provide functionality as a single module. Further, one or more modules may operate in conjunction with one another so that, for example, one module acts as a service or an extension of another module. Also, each module, data store, component, program, executable, data item, functional unit, or other item illustrated within a storage device may include multiple components, sub-components, modules, sub-modules, data stores, and/or other components or modules or data stores not illustrated. Further, each module, data store, component, program, executable, data item, functional unit, or other item illustrated within a storage device may be implemented in various ways. For example, each module, data store, component, program, executable, data item, functional unit, or other item illustrated within a storage device may be implemented as a downloadable or pre-installed application or “app.” In other examples, each module, data store, component, program, executable, data item, functional unit, or other item illustrated within a storage device may be implemented as part of an operating system executed on a computing device.

In the example of FIG. 2, and in accordance with one or more aspects of the present disclosure, computing system 280 may analyze information stored within contacts data store 294 and determine dates and events of interest associated with one or more contacts having information maintained in contacts data store 294. For instance, relationship assistant module 293 may access data within contacts data store 294 and determine dates of interest (birthdays, anniversaries, etc.) for one or more contacts stored within contacts data store 294. Relationship assistant module 293 may determine such dates and/or events of interest in a manner similar to that described in connection with computing system 180 of FIG. 1. Relationship assistant module 293 may update contacts data store 294 with information about such dates and/or events of interest.

Computing system 280 may periodically, occasionally, and/or continually analyze, monitor, and/or query one or more information sources 240 for information. For example, relationship assistant module 293 may construct, in a manner similar to that described in connection with computing system 180 of FIG. 1, one or more search queries to identify information about one or more contacts included within contacts data store 294. Relationship assistant module 293 may cause communication unit 285 to output a signal over network 205. One or more information sources 240 may detect a signal, and determine that the signal corresponds to one or more search queries or requests for information about one or more contacts stored within contacts data store 294. One or more information sources 240 may use the search queries or requests to research and/or determine information. Such information may include news events or other information about or relating to contacts maintained within contacts data store 294. One or more information sources 240 may send results of the research over network 205 to computing system 280. Communication unit 285 of computing system 280 may detect input and output to relationship assistant module 293 an indication of input. Relationship assistant module 293 may determine that the input corresponds to results of one or more search queries or requests sent by computing system 280 to information sources 240. Relationship assistant module 293 may analyze the results and update contacts data store 294 with information derived from the results.

Computing system 280 may alternatively, or in addition, analyze a feed of information provided by one or more information sources 240. For example, relationship assistant module 293 may cause communication unit 285 to output a signal over network 205. One or more information sources 240 may detect a signal and determine that the signal corresponds to a request to syndicate, distribute, publish, or provide access to a feed of information. One or more information sources 240 may thereafter occasionally or periodically send information over network 205 to computing system 280. Relationship assistant module 293 of computing system 280 may receive an indication of such information and identify information that is relevant to one or more contacts stored within contacts data store 294. Relationship assistant module 293 may update contacts data store 294 to include some or all of the identified information in each relevant record within contacts data store 294.

Computing device 210 may communicate with computing system 280 when managing information and/or interactions with contacts. For example, user interface device 221 of computing device 210 may detect input and output to user interface module 231 an indication of input. User interface module 231 may output to relationship management module 233 information about the input. Relationship management module 233 may determine that the input corresponds to a request to browse to or interact with computing system 280. Relationship management module 233 may cause communication unit 215 to output a signal over network 205. Communication unit 285 of computing system 280 may detect a signal over network 205 and output to accounts module 295 an indication of input. Accounts module 295 may determine that the signal corresponds to authentication credentials for a user of computing device 210. Accounts module 295 may access information in relationship manager accounts data store 296 and determine that the authentication credentials correspond to those for a relationship manager having an account within relationship manager accounts data store 296. Accounts module 295 may communicate with computing device 210 over network 205 and establish a session. Computing device 210 and computing system 280 may further communicate over network 205 when a user of computing device 210 seeks to view, update, or use information relating to the relationship manager's list of contacts.

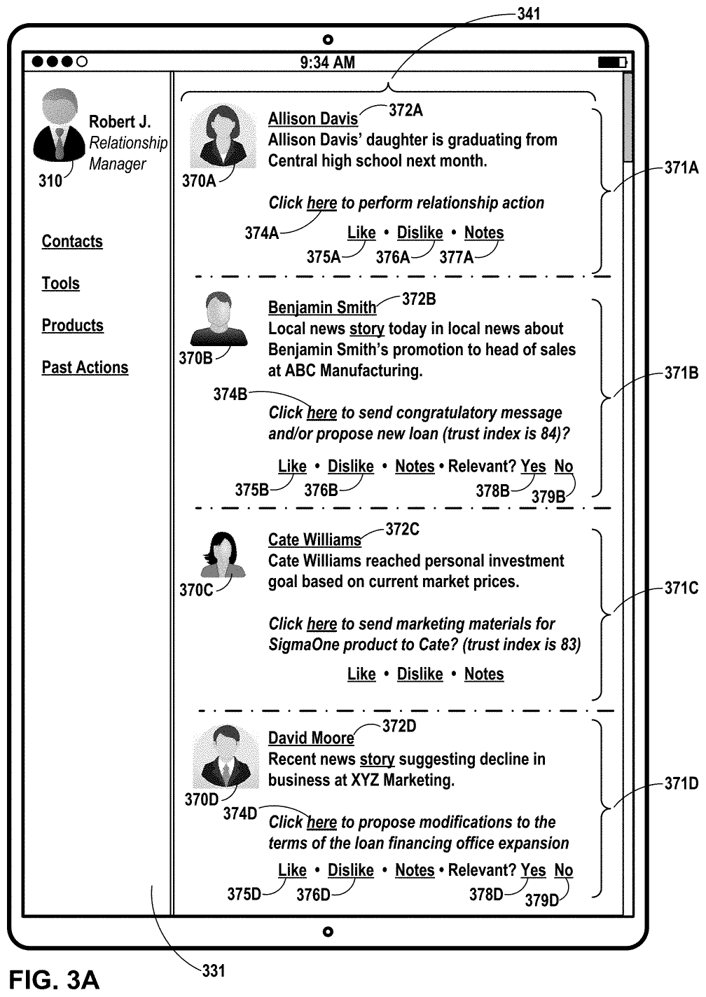

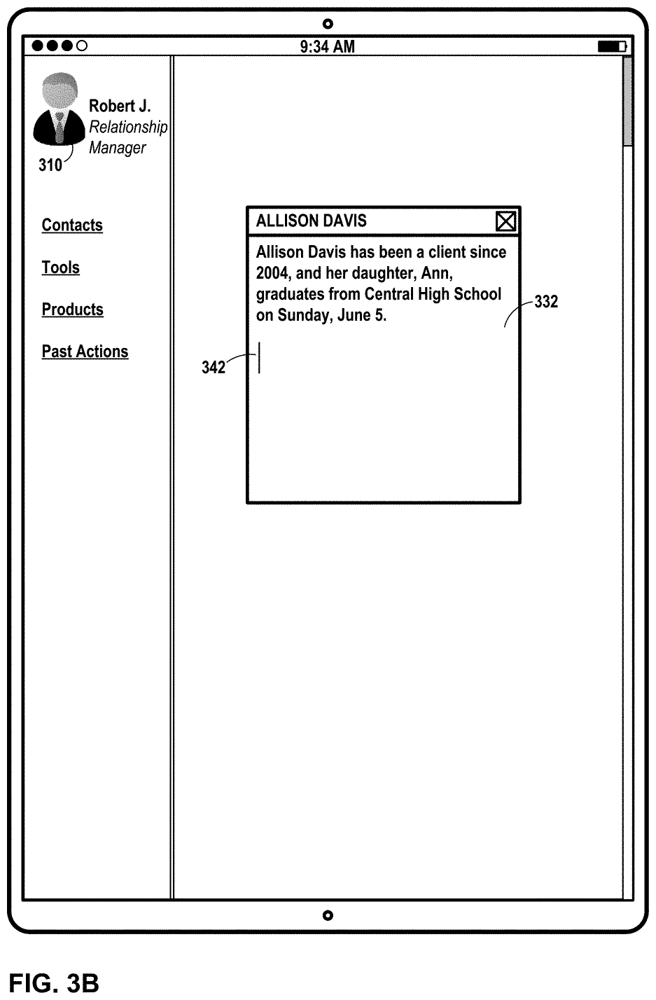

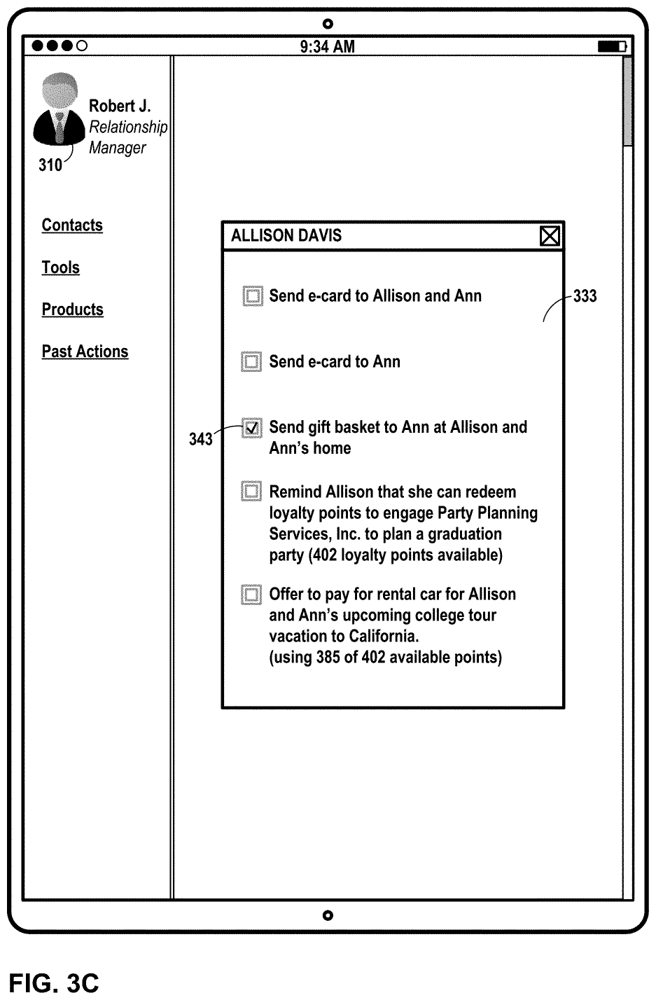

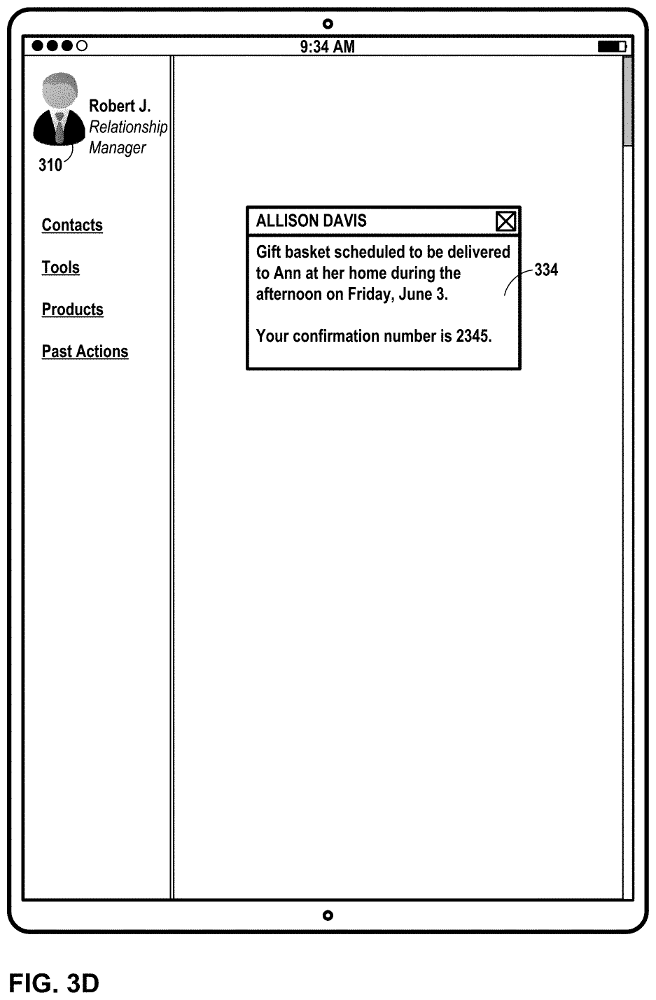

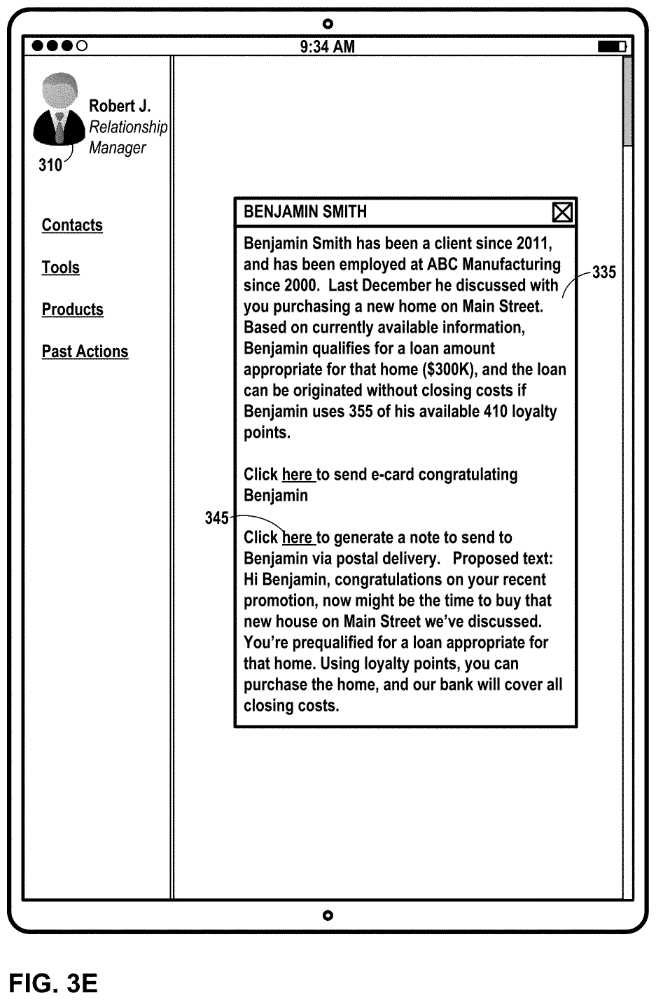

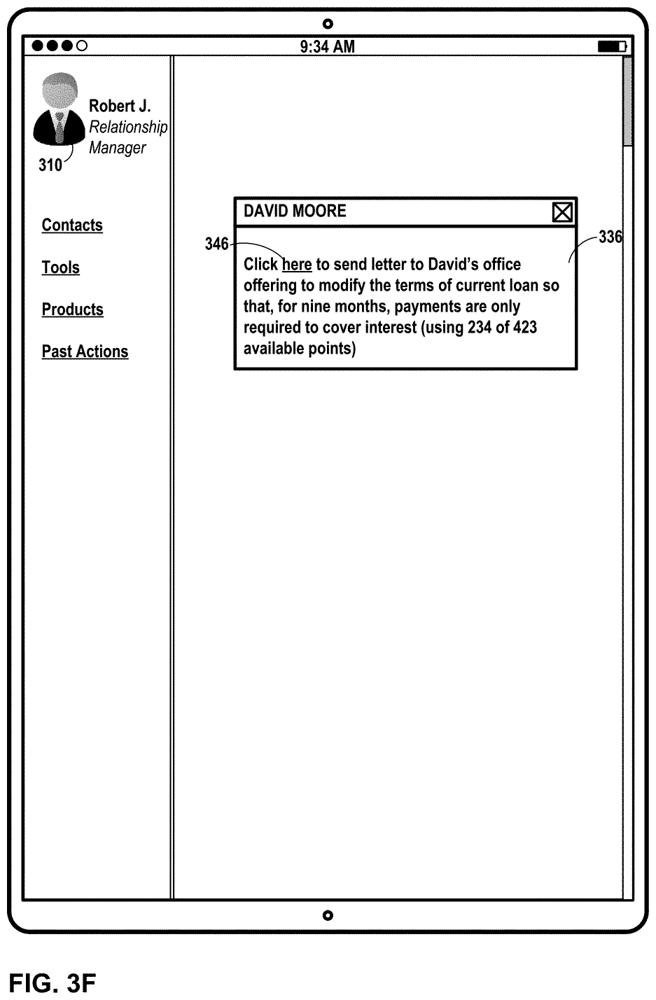

FIG. 3A is a conceptual diagram illustrating an example user interface presented by an example computing device in accordance with one or more aspects of the present disclosure. In the example of FIG. 3A, user interface 331 may correspond to a user interface presented by display 223 of FIG. 2. Although illustrated as a graphical user interface in FIG. 3A, in other examples, a different user interface may present similar information and options, and such a user interface may include a voice-based or voice-controlled user interface (e.g., a personal voice-activated assistant), a motion-controlled or visual user interface (e.g., augmented reality or virtual reality user interface), a text-based user interface, a console or command-based user interface, or any other type of user interface now known or hereafter conceived.

FIG. 3B, FIG. 3C, FIG. 3D, FIG. 3E, and FIG. 3F are each a conceptual diagram illustrating additional example user interfaces presented by an example computing device in accordance with one or more aspects of the present disclosure, as further described herein. One or more aspects of FIG. 3A through FIG. 3F may be described herein within the context of FIG. 2.

In the example of FIG. 3A, user interface 331 illustrates a news feed of information about one or more contacts relating to relationship manager 310. User interface 331 includes profile pictures of relationship manager 310, contact 370A, contact 370B, contact 370C, and contact 370D. For contact 370A, contact news item 371A is presented, which includes contact profile link 372A, link 374A, “like” link 375A, and “dislike” link 376A.

With reference to FIG. 2 and FIG. 3A, and in accordance with one or more aspects of the present disclosure, computing device 210 may present, in a news feed format as illustrated in FIG. 3A, information about contacts associated with the authenticated user of computing device 210. For example, user interface device 221 of computing device 210 may detect input and output to user interface module 231 an indication of input. User interface module 231 may output to relationship management module 233 information about the input. Relationship management module 233 may determine that the input corresponds to a request to browse to, retrieve information from, or interact with computing system 280. Relationship management module 233 may cause communication unit 215 to output a signal over network 205.

Communication unit 285 of computing system 280 may detect a signal over network 205 and output to relationship assistant module 293 an indication of input. Relationship assistant module 293 may determine that the input corresponds to a request for information about one or more contacts associated with the authenticated user of computing device 210. Relationship assistant module 293 may access information in contacts data store 294 and select, for presentation at computing device 210, information about contacts associated with the user of computing device 210. Relationship assistant module 293 may cause communication unit 285 to output a signal over network 205. Communication unit 215 of computing device 210 may detect a signal over network 205. Communication unit 215 may output to relationship management module 233 an indication of the signal. Relationship management module 233 may determine that the signal corresponds to information sufficient to present a user interface. Relationship management module 233 may cause user interface device 221 to present user interface 331 at display 223 as illustrated in FIG. 3A.

In FIG. 3A, user interface 331 includes information about one or more personal contacts maintained by the authenticated user operating computing device 210. In the example of FIG. 3A, the authenticated user operating computing device 210 is relationship manager 310. User interface 331 includes news feed 341. News feed 341 may present information about recent or upcoming events relating to one or more contacts associated with the authenticated user of computing device 210. News feed 341 may also present proposed relationship actions that may be performed on behalf of the relationship manager operating computing device 210.

As illustrated in FIG. 3B, computing device 210 may present more detailed profile information about one or more of the contacts mentioned in news feed 341. For example, with reference to FIG. 3A and FIG. 2, user interface device 221 may detect input at or near where display 223 presents contact profile link 372A in FIG. 3A. User interface device 221 may output to user interface module 231 an indication of input. User interface module 231 may output to relationship management module 233 information about the input. Relationship management module 233 may determine that the input corresponds to a selection, by a user of computing device 210, of contact profile link 372A. In response, relationship management module 233 may cause user interface device 221 to present user interface 332 at display 223, as illustrated in FIG. 3B. In an alternative example, computing device 210 may similarly respond to selection of “notes” link 377A by presenting user interface 332 as illustrated in FIG. 3B.

In some examples, relationship management module 233 may retrieve information from computing system 280 over network 205 in order to present user interface 332. In other examples, relationship management module 233 may access previously-stored information within storage device 230 to present user interface 332 at display 223.

In a similar manner, computing device 210 may present profile information about other contacts 370 in response to selection of contact profile link 372B, contact profile link 372C, and contact profile link 372D.

In the example of FIG. 3B, user interface 332 includes further information, notes, results of research, and other information about contact 370A. In some examples, the information included in user interface 332 may include information derived from input previously received by computing device 210 or previously stored as contact information 234. Such information may have been previously communicated over network 205 to computing system 280 and stored at contacts data store 294. User interface 332 may also include information determined by computing system 280, based on queries, research, scraping the web, or other information derived, accessed, or otherwise obtained by computing system 280.

Computing device 210 may further update the information included in user interface 332 in response to user input. For example, still referring to FIG. 3B and FIG. 2, user interface device 221 may detect input while user interface 332 is presented as shown in FIG. 3B. In some examples, user interface device 221 may detect input at a location that corresponds to cursor 342 within user interface 332. User interface device 221 may output to user interface module 231 an indication of input. User interface module 231 may output to relationship management module 233 information about the input. Relationship management module 233 may determine that the input corresponds to further notes, entered by a user of computing device 210, about contact 370A. For instance, a relationship manager (i.e., the user operating computing device 210) may enter notes of a conversation that he or she has had with contact 370A about financial plans, financial advice rendered by the relationship manager, or about other topics. In response to detecting such input, relationship management module 233 may cause user interface module 231 to update user interface 332 to include further information, entered by a user of computing device 210, about contact 370A.

In addition, relationship management module 233 may cause communication unit 215 to output a signal over network 205. Communication unit 285 of computing system 280 may detect a signal and output to relationship assistant module 293 an indication of the signal. Relationship assistant module 293 may determine that the signal corresponds to the further information about contact 370A. Relationship assistant module 293 may store the further information in contacts data store 294.

Computing device 210 may present options for performing a relationship action for one or more contacts 370. For example, with reference to FIG. 3A and FIG. 2, user interface device 221 may detect input at or near where display 223 presents link 374A. User interface device 221 may output to user interface module 231 an indication of input. User interface module 231 may output to relationship management module 233 information about the input. Relationship management module 233 may determine that the input corresponds to selection, by a user of computing device 210, of link 374A. Relationship management module 233 may cause communication unit 215 to send a signal over network 205. Communication unit 285 may detect a signal and output to relationship assistant module 293 an indication of the signal. Relationship assistant module 293 may determine that the signal corresponds to a request, by a user of computing device 210, to perform a relationship action for contact 370A. Relationship assistant module 293 may cause communication unit 285 to output a signal over network 205.

Communication unit 215 may detect the signal and output to relationship management module 233 an indication of the signal. Relationship management module 233 may, responsive to the signal, cause user interface device 221 to present user interface 333, as illustrated in FIG. 3C. In the example of FIG. 3C, user interface 333 presents background information similar to that presented in user interface 332 of FIG. 3B, and also presents options for performing a relationship action for contact 370A. As illustrated in the example of FIG. 3C, relationship actions may include sending notifications, communications, and/or gifts to contact 370A or to a family member of contact 370A. Relationship actions may alternatively, or in addition, include providing other items or services of value, such as paying for a car rental service for an upcoming vacation.

Computing device 210 may cause a relationship action to be performed. For example, with reference to FIG. 3C and FIG. 2, user interface device 221 may detect input at or near where display 223 presents relationship action item 343. User interface device 221 may output to user interface module 231 an indication of input. User interface module 231 may output to relationship management module 233 information about the input. Relationship management module 233 may determine that the input corresponds to selection, by a user of computing device 210, of relationship action item 343. Relationship management module 233 may, in response to the selection, cause communication unit 215 to output a signal over network 205. Communication unit 285 of computing system 280 may detect a signal and output to relationship assistant module 293 an indication of the signal. Relationship assistant module 293 may determine that the signal corresponds to a request, by a user of computing device 210, to send a gift basket to the home of contact 370A, addressed to both contact 370A and the daughter of contact 370A. Relationship assistant module 293 may cause communication unit 285 to send a signal over network 205 to service provider computing system 260. Service provider computing system 260 may determine that the signal corresponds to a request to deliver a gift basket to the home of contact 370A. Service provider computing system 260 may arrange, perform, or otherwise cause delivery of the requested gift basket to the home of contact 370A. Service provider computing system 260 may communicate a confirmation signal over network 205 to computing system 280. Communication unit 285 may receive a signal and output an indication of the signal to relationship assistant module 293. Relationship assistant module 293 may determine that the signal corresponds to confirmation of the request sent to service provider computing system 260. Relationship assistant module 293 may cause communication unit 285 to output a signal over network 205. Communication unit 215 of computing device 210 may detect the signal, and relationship management module 233 may determine that the signal corresponds to confirmation that the relationship action has been initiated and/or confirmed. Relationship management module 233 may cause user interface device 221 to present user interface 334, as illustrated in FIG. 3D.

Relationship manager 310 may express a favorable view of one or more contact news items 371 or a relationship action proposed within one or more contact news items 371. For example, referring again to FIG. 3A and FIG. 2, user interface device 221 may detect input at or near where display 223 presents “like” link 375A. User interface device 221 may output to user interface module 231 an indication of input. User interface module 231 may output to relationship management module 233 information about the input. Relationship management module 233 may determine that the input corresponds to a selection, by a user of computing device 210 (i.e., relationship manager 310), of “like” link 375A. Relationship management module 233 may cause communication unit 215 to output a signal over network 205. Communication unit 285 of computing system 280 may detect a signal, and relationship assistant module 293 of computing system 280 may determine that the signal corresponds to an indication that relationship manager 310 at computing device 210 has selected “like” link 375A associated with contact news item 371A. In some examples, relationship assistant module 293 may interpret the signal as an indication that relationship manager 310 “likes,” is receptive to, and/or prefers to continue receive news items similar to contact news item 371A within news feed 341. Relationship assistant module 293 may update contacts data store 294 and/or relationship manager accounts data store 296 to indicate that relationship manager 310 has expressed a favorable opinion of contact news item 371A.

Alternatively, relationship manager 310 may express an unfavorable view of one or more contact news items 371 or a relationship action proposed within one or more contact news items 371. For example, still referring to FIG. 3A and FIG. 2, user interface device 221 may detect input at or near where display 223 presents “dislike” link 376A, and relationship management module 233 may determine that the input corresponds to a selection of “dislike” link 376A. Relationship management module 233 may cause communication unit 215 to communicate with computing system 280 over network 205, and relationship assistant module 293 of computing system 280 may determine that relationship manager 310 has selected “dislike” link 376A. Relationship assistant module 293 may update contacts data store 294 and/or relationship manager accounts data store 296 to indicate that relationship manager 310 has expressed an unfavorable opinion about contact news item 371A. In some examples, relationship assistant module 293 may interpret this signal as an indication that relationship manager 310 “dislikes,” is not receptive to, and/or prefers not to see items similar to contact news item 371A within news feed 341. For instance, relationship manager 310 may have a personal preference such that he or she might not be comfortable performing relationship actions in response to graduations, birthdays, anniversaries, or the like. Alternatively, or in addition, relationship manager 310 might not be comfortable performing relationship actions for family members of contact 370A.

Computing device 210 and/or computing system 280 may fine-tune the content of news feed 341 based on input detected at computing device 210. Relationship assistant module 293 may receive numerous indications of favorable or unfavorable opinions about one or more contact news items 371. Relationship assistant module 293 may use such information to determine what types of information or relationship action proposals to include in future news feeds. In this way, relationship assistant module 293 may learn preferences expressed by relationship manager 310, and may use such preferences, as expressed through “like” link 375A and “dislike” link 376A, to shape or tailor future news feeds for relationship manager 310. Similarly, to the extent that relationship assistant module 293 receives similar preferences for other relationship managers operating other computing devices 210, relationship assistant module 293 may use such information to shape or tailor future news feeds for such other relationship managers.

In another example, computing device 210 may present options for initiating a relationship action for contact 370B. For example, referring again to FIG. 3A and FIG. 2, user interface device 221 may detect input at or near where display 223 presents link 374B, and relationship management module 233 may determine that the input corresponds to a selection of link 374B. In response, relationship management module 233 may cause communication unit 215 to send a signal over network 205. Relationship assistant module 293 of computing system 280 may receive an indication of the signal and determine that the signal corresponds to a request, by relationship manager 310, to perform a relationship action for contact 370B. Relationship assistant module 293 may further determine that the requested relationship action involves sending a congratulatory message and proposing a new loan for contact 370B. Relationship assistant module 293 may cause communication unit 285 to output a signal over network 205. Communication unit 215 may detect the signal and output to relationship management module 233 an indication of the signal. Relationship management module 233 may, responsive to the signal, cause user interface device 221 to present user interface 335, as illustrated in FIG. 3E, presenting options for relationship actions for contact 370B.

Referring to now to FIG. 3E and FIG. 2, user interface device 221 may detect input that relationship management module 233 determines corresponds to selection of relationship action link 345. In response, relationship management module 233 may cause communication unit 215 to output a signal over network 205 that may be received by relationship assistant module 293 of computing system 280. Relationship assistant module 293 may determine that the signal corresponds to a request to communicate the message illustrated in user interface 335 of FIG. 3E to contact 370B. Relationship assistant module 293 may output a signal over network 205 that financial services system 250 determines is a command to generate a communication and promotional materials about a loan tailored to contact 370B. Financial services system 250 may generate and/or print the requested communication and loan information. Financial services system 250 may arrange for the communication and loan information to be delivered by postal mail to an address associated with contact 370B.

Computing device 210 and/or computing system 280 may use “relevant” links 378 and “not relevant” links 379 to fine-tune research performed by relationship assistant module 293 of computing system 280. For example, referring again to FIG. 3A and FIG. 2, user interface device 221 may detect input at or near where display 223 presents “not relevant” link 379B, and relationship management module 233 may determine that the input corresponds to a selection of “not relevant” link 379B. Relationship management module 233 may cause communication unit 215 to output a signal over network 205. Communication unit 285 of computing system 280 may detect a signal, and relationship assistant module 293 of computing system 280 may determine that the signal corresponds to an indication that relationship manager 310 has selected “not relevant” link 379B associated with contact news item 371B. Relationship assistant module 293 may update contacts data store 294 and/or relationship manager accounts data store 296 to indicate that the authenticated user at computing device 210 has indicated that contact news item 371B is not relevant to contact 370B. For instance, the news story reference in contact news item 371B might actually be referring to a different “Benjamin Smith,” so that contact 370B is not actually the person that was the subject of the referenced story. Accordingly, it may be inappropriate to perform a relationship action with respect to contact 370B based on the story referenced in contact news item 371B. In another example, where the news story referenced in contact news item 371B does properly refer to contact 370B, relationship assistant module 293 may detect input indicating that the authenticated user of computing device 210 has selected “relevant” link 378B. In such an example, relationship assistant module 293 may update contacts data store 294 to indicate that the news story is relevant to contact 370B. Relationship assistant module 293 may use information received about what information is actually relevant to contact 370B to fine tune the research generated for contact 370B. In some examples, such information may help information sources 240 and/or relationship assistant modules 293 to discern which references to “Benjamin Smith” are likely to actually refer to contact 370B.

In a further example, computing device 210 may propose a relationship action for contact 370D. For instance, referring again to FIG. 3A, user interface device 221 may detect input at or near where display 223 presents link 374D, and relationship management module 233 may determine that the input corresponds to a selection of link 374D. Relationship management module 233 may cause communication unit 215 to send a signal over network 205, and relationship assistant module 293 of computing system 280 may determine that the signal corresponds to a request, by relationship manager 310, to perform a relationship action for contact 370D. Relationship assistant module 293 may further determine that the requested relationship action involves proposing modifications to a loan that contact 370D has received to finance a business expansion. Relationship assistant module 293 may cause communication unit 285 to output a signal over network 205. Computing device 210 may detect the signal, and relationship management module 233 may, responsive to the signal, cause user interface device 221 to present user interface 336, as illustrated in FIG. 3F.

Referring now to FIG. 3F and FIG. 2, user interface device 221 may detect input that relationship management module 233 determines corresponds to selection of relationship action link 346. In response, relationship management module 233 may cause communication unit 215 to output a signal over network 205. Relationship assistant module 293 may receive an indication of the signal and determine that the signal corresponds to selection of relationship action link 346 in user interface 336. In response, relationship assistant module 293 may send a signal over network 205 to financial services computing system 250. Financial services computing system 250 may receive the signal and in response, generate and send a communication to contact 370D consistent with the proposed relationship action illustrated in user interface 336.

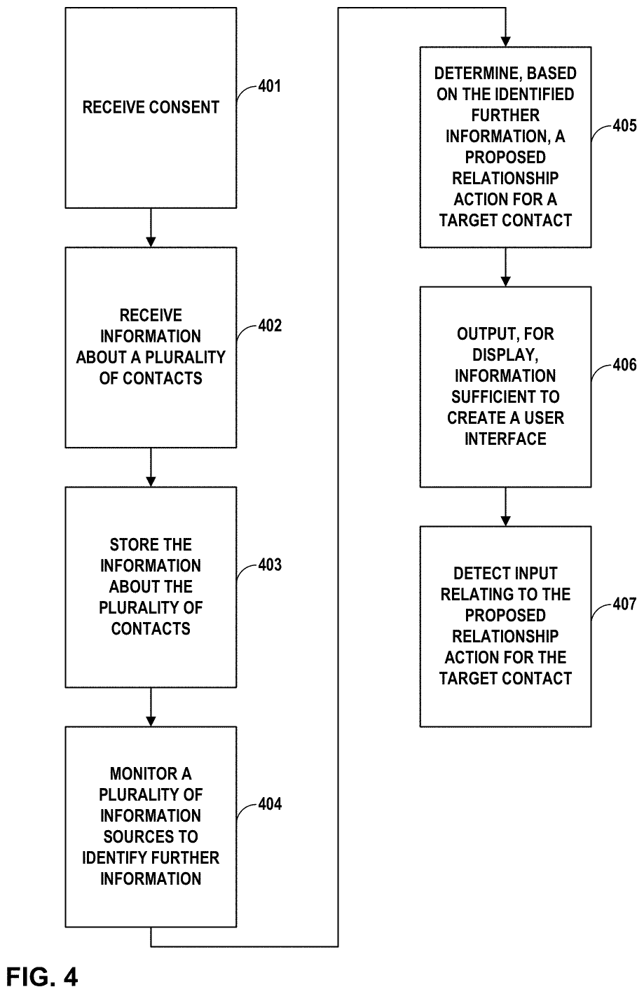

FIG. 4 is a flow diagram illustrating operations performed by an example computing system in accordance with one or more aspects of the present disclosure. FIG. 4 is described below within the context of computing system 280 of FIG. 2 and the user interfaces of FIG. 3. In other examples, operations described in FIG. 4 may be performed by one or more other components, modules, systems, or devices. Further, in other examples, operations described in connection with FIG. 4 may be merged, performed in a difference sequence, or omitted.

In the example of FIG. 4, and in accordance with one or more aspects of the present disclosure, computing system 280 may receive consent from the user to research, process, and/or analyze information about at least one of a plurality of contacts (401). For example, particularly in situations where a relationship manager may use personal information received from a contact to further develop a relationship that leads to marketing products and/or services to that contact, computing system 280 may request permission from each of contacts 370. In some examples, computing system 280 may send, electronically or otherwise, a communication, a privacy notice, or other information describing operations that may be performed by computing system 280. After providing such information, computing system may determine that a contact has provided unambiguous and explicit consent to use such information. Computing system 280 might receive such consent periodically (e.g., once a day, once a month, or annually), or in some examples, computing system 280 may receive such consent only once (e.g., upon establishing a relationship with a relationship manager or a user of computing device 210. If no such consent is received, computing system 280 may refrain from performing other operations illustrated in FIG. 4 until such time that explicit consent is obtained.

Computing system 280 may receive information about a plurality of contacts (402). For example, communication unit 285 of computing system 280 may detect input over network 205 and output to relationship assistant module 293 an indication of input. Relationship assistant module 293 may determine that the input corresponds to information from computing device 210 about a plurality of contacts.

Computing system 280 may store the information about the plurality of contacts (403). For example, relationship assistant module 293 may output to contacts data store 294 the information about the plurality of contacts. Contacts data store 294 may receive the information and store the information.

Computing system 280 may monitor a plurality of information sources to identify, based on the stored information, further information associated with at least one of the plurality of contacts (404). For example, relationship assistant module 293 may cause communication unit 285 to output a signal over network 205. One or more information source computing systems 240 may receive the signal and determine that it corresponds to a search query. One or more information source computing systems 240 may perform a search based on the search query, and output over network 205 results of the search. Relationship assistant module 293 may receive an indication of the results, and determine, based on the results, further information associated with at least one of the contacts.

Computing system 280 may determine, based on the identified further information, a proposed relationship action for a target contact, the target contact being one of the plurality of contacts for which further information has been identified (405). For example, relationship assistant module 293 may, based on the further information, determine that one of the plurality of contacts was recently promoted by his or her employer. Relationship assistant module 293 may identify a proposed congratulatory gift that may be send to the recently promoted contact.

Computing system 280 may output, for display, information sufficient to create a user interface, wherein the information sufficient to create a user interface includes information about the about the target contact and the proposed relationship action (406). For example, relationship assistant module 293 may cause communication unit 285 to output, over network 205, a signal. Communication unit 215 of computing device 210 may detect a signal and output to relationship management module 233 information about the signal. Relationship management module 233 may determine that the signal includes information sufficient to create a user interface that includes information indicating that the contact was recently promoted, and that also includes a proposed congratulatory gift to be sent to the contact.

Computing system 280 may detect input relating to the proposed relationship action for the target contact (407). For example, communication unit 285 may detect a signal over network 205, and output to relationship assistant module 293 information about the signal. Relationship assistant module 293 may determine that the signal corresponds to authorization to perform the proposed relationship action, based, for example, on a user of computing device 210 interacting with a user interface presented at computing device 210. Relationship assistant module 293 may initiate performance of the proposed relationship action.

Although FIG. 4 has been described within the context of operations performed by computing system 280, in other examples, computing device 210 may perform at least some of such operations. For instance, in the example of FIG. 4, and in accordance with one or more aspects of the present disclosure, computing device 210 may receive consent (401), as previously described.

Computing device 210 may receive information about a plurality of contacts (402). For example, user interface device 221 of computing device 210 may detect input from a user of computing device 210 that may correspond to information (e.g., notes) about a plurality of contacts.

Computing device 210 may store the information about the plurality of contacts (403). For example, relationship management module 233 may output to or store within contact information 234 information about the plurality of contacts. In other examples, computing device 210 may cause communication unit 215 to send such information over network 205 to computing system 280 for storage within contacts data store 294.

Computing device 210 may monitor a plurality of information sources to identify, based on the stored information, further information associated with at least one of the plurality of contacts (404). For example, relationship management module 233 may cause communication unit 215 to output a signal over network 205. One or more information source computing systems 240 may receive the signal and determine that it corresponds to a search query. One or more information source computing systems 240 may perform a search based on the search query, and output over network 205 results of the search. Relationship management module 233 may receive an indication of the results, and determine, based on the results, further information associated with at least one of the contacts.

Computing device 210 may determine, based on the identified further information, a proposed relationship action for a target contact, the target contact being one of the plurality of contacts for which further information has been identified (405). For example, relationship management module 233 may, based on the further information, determine that one of the plurality of contacts was recently promoted. Relationship management module 233 may identify a proposed congratulatory gift that may be send to the recently promoted contact.

Computing device 210 may output, for display, information sufficient to create a user interface, wherein the information sufficient to create a user interface includes information about the about the target contact and the proposed relationship action (406). For example, relationship management module 233 may cause user interface device 221 to present a user interface (e.g., similar to user interface 331) that includes information indicating that the target contact was recently promoted, and that also includes a proposed congratulatory gift to be sent to the target contact.

Computing device 210 may detect input relating to the proposed relationship action for the target contact (407). For example, user interface device 221 may detect input and output to relationship management module 233 an indication of input. Relationship management module 233 may determine that the input corresponds to an interaction with a user interface presented at computing device 210, and relationship management module 233 may further determine that the input corresponds to authorization to perform the proposed relationship action. Computing device 210 may send a signal to service provider computing system 260 to cause the proposed relationship action to be initiated.

For processes, apparatuses, and other examples or illustrations described herein, including in any flowcharts or flow diagrams, certain operations, acts, steps, or events included in any of the techniques described herein can be performed in a different sequence, may be added, merged, or left out altogether (e.g., not all described acts or events are necessary for the practice of the techniques). Moreover, in certain examples, operations, acts, steps, or events may be performed concurrently, e.g., through multi-threaded processing, interrupt processing, or multiple processors, rather than sequentially. Further certain operations, acts, steps, or events may be performed automatically even if not specifically identified as being performed automatically. Also, certain operations, acts, steps, or events described as being performed automatically may be alternatively not performed automatically, but rather, such operations, acts, steps, or events may be, in some examples, performed in response to input or another event.

In one or more examples, the functions described may be implemented in hardware, software, firmware, or any combination thereof. If implemented in software, the functions may be stored, as one or more instructions or code, on and/or transmitted over a computer-readable medium and executed by a hardware-based processing unit. Computer-readable media may include computer-readable storage media, which corresponds to a tangible medium such as data storage media, or communication media including any medium that facilitates transfer of a computer program from one place to another (e.g., pursuant to a communication protocol). In this manner, computer-readable media may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can include RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used may refer to any of the foregoing structure or any other structure suitable for implementation of the techniques described. In addition, in some aspects, the functionality described may be provided within dedicated hardware and/or software modules. Also, the techniques could be fully implemented in one or more circuits or logic elements.

The techniques of this disclosure may be implemented in a wide variety of devices or apparatuses, including a wireless handset, a mobile or non-mobile computing device, a wearable or non-wearable computing device, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperating hardware units, including one or more processors as described above, in conjunction with suitable software and/or firmware.

1. A method comprising:
receiving, by a computing system controlled by a financial institution, information about a plurality of contacts including a first target contact and a second target contact, each of the contacts representing a person;
storing, by the computing system, the information about the plurality of contacts;
monitoring, by the computing system, a plurality of information sources;
identifying, by the computing system and based on monitoring the information sources, further information about the first target contact;
determining, by the computing system, and based on the further information about the first target contact, a proposed adjustment to a banking service being provided by the financial institution to the first target contact, wherein the proposed adjustment is of financial value to the first target contact;
outputting, by the computing system and for display, information sufficient to create a user interface that includes a news item about the first target contact, a description of the proposed adjustment that will be provided to the first target contact if the proposed adjustment is authorized, a first selectable display element for authorizing the proposed adjustment, and a second selectable display element for expressing an opinion about the proposed adjustment for the first target contact;
detecting, by the computing system, input authorizing the proposed adjustment for the first target contact, wherein the input includes selection of the first selectable display element;
responsive to detecting the input, performing, by the computing system, the proposed adjustment;
detecting, by the computing system, input expressing a favorable opinion of the proposed adjustment for the first target contact, wherein the input includes selection of the second selectable display element;
storing, by the computing system, information about the favorable opinion of the proposed adjustment for the first target contact;
identifying, by the computing system and based on monitoring the information sources, further information about the second target contact;
determining, by the computing system after detecting input expressing the favorable opinion and based on both the further information about the second contact and the information about the favorable opinion of the proposed adjustment for the first target contact, a second proposed adjustment for the second target contact, wherein the second proposed adjustment is an adjustment to a banking service being provided by the financial institution to the second target contact, and is of financial value to the second target contact; and
responsive to input authorizing the second proposed adjustment for the second target contact, performing the second proposed adjustment.

2. The method of claim 1, the method further comprising:
receiving, by the computing system, a confirmation that the proposed adjustment was performed; and
updating, by the computing system, a data store to include information reflecting performance of the proposed adjustment for the first target contact.

3. The method of claim 2, further comprising:
determining, by the computing system, an expected trust score for the first target contact, the expected trust score indicating an expected likelihood of the first target to be receptive to marketing communications from the financial institution and being based on at least the information reflecting performance of the proposed adjustment;
determining, by the computing system, that the expected trust score exceeds a predetermined threshold; and
based on the expected trust score exceeding the predetermined threshold, marketing a service to the first target contact.

4. (canceled)

5. The method of claim 1, wherein the proposed adjustment for the second target contact is the same as the proposed adjustment for the first target contact.

6. The method of claim 1, further comprising:
maintaining, by the computing system, for at least a subset of the plurality of contacts, a loyalty points count that reflects at least one of: a history of prior product purchases made by each respective contact, a history of prior service purchases made by each respective contact, or an indication of a relationship length for each respective contact; and
wherein determining the proposed adjustment for the second target contact includes generating, by the computing system and further based on the loyalty points count, the proposed adjustment for the second target contact.

7. The method of claim 1, wherein outputting information sufficient to create a user interface includes outputting, for one or more of the plurality of contacts, in a news feed format, information about a recent event associated with each respective contact.

8. The method of claim 1, wherein outputting information sufficient to create a user interface includes outputting, for the first target contact, information about a trust score that is based on a plurality of previously performed relationship actions for the first target contact.

9. A computing system comprising:
at least one processor; and
at least one storage device that stores instructions that, when executed, configure the at least one processor to:
receive information about a plurality of contacts including a first target contact and a second target contact, each of the contacts representing a person,
store the information about the plurality of contacts,
monitor a plurality of information sources,
identify, based on monitoring the information sources, further information about the first target contact;
determine, based on the further information about the first target contact, a proposed adjustment to a banking service being provided by a financial institution to for the first target contact, wherein the proposed adjustment is of financial value to the first target contact,
output, for display, information sufficient to create a user interface that includes a news item about the first target contact, a description of the proposed adjustment that will be provided to the first target contact if the proposed adjustment is authorized, a first selectable display element for authorizing the proposed adjustment, and a second selectable display element for expressing an opinion about the proposed adjustment for the first target contact,
detect input authorizing the proposed adjustment for the first target contact, wherein the input includes selection of the first selectable display element,
responsive to detecting input, initiate the proposed adjustment,
detect input expressing a favorable opinion of the proposed adjustment for the first target contact, wherein the input includes selection of the second selectable display element,
store information about the favorable opinion of the proposed adjustment for the first target contact,
identify, based on monitoring the information sources, further information about the second target contact; and
determine, after detecting input expressing the favorable opinion and based on both the further information about the second contact and the information about the favorable opinion of the proposed adjustment for the first target contact, a proposed adjustment for the second target contact, wherein the second proposed adjustment is an adjustment to a banking service being provided to the second target contact, and is of financial value to the second target contact.

10. The computing system of claim 9, wherein the instructions, when executed, further configure the at least one processor to:
receive a confirmation that the proposed adjustment was performed; and
update a data store to include information reflecting performance of the proposed adjustment for the first target contact.

11. The computing system of claim 10, wherein the instructions, when executed, further configure the at least one processor to:
determine an expected trust score for the first target contact, the expected trust score indicating an expected likelihood of the first target to be receptive to marketing communications from the financial institution and being based on at least the information reflecting performance of the proposed adjustment;
determine that the expected trust score exceeds a predetermined threshold; and
based on the expected trust score exceeding the predetermined threshold, market a service to the first target contact.

12. (canceled)

13. The computing system of claim 9, wherein the proposed adjustment for the second target contact is the same as the proposed adjustment for the first target contact.

14. The computing system of claim 9, wherein the instructions, when executed, further configure the at least one processor to:
maintain, for each of the plurality of contacts, a loyalty points count that reflects at least one of: a history of prior product purchases made by each respective contact, a history of prior service purchases made by each respective contact, or an indication of a relationship length for each respective contact; and
wherein to determine the proposed adjustment for the second target contact, the at least one processor is further configured to generate, based on the loyalty points count, the proposed adjustment for the second target contact.

15. The computing system of claim 9, wherein to output information sufficient to create a user interface, the instructions, when executed, further configure the at least one processor to output, for one or more of the plurality of contacts, in a news feed format, information about a recent event associated with each respective contact.

16. The computing system of claim 9, wherein to output information sufficient to create a user interface, the instructions, when executed, further configure the at least one processor to output, for the first target contact, information about a trust score that is based on a plurality of previously performed relationship actions for the first target contact.

17. A non-transitory computer-readable storage medium comprising instructions that, when executed, configure one or more processors of a computing system to:
receive information about a plurality of contacts including a first target contact and a second target contact, each of the contacts representing a person;
store the information about the plurality of contacts;
monitor a plurality of information sources;
identify, based on monitoring the information sources, further information about the first target contact;
determine, based on the further information about the first target contact, a proposed adjustment to a banking service being provided by a financial institution to the first target contact, wherein the proposed adjustment is of financial value to the first target contact;
output, for display, information sufficient to create a user interface that includes a news item about the first target contact, a description of the proposed adjustment that will be provided to the first target contact by a service provider if the proposed adjustment is authorized, a first selectable display element for authorizing the proposed adjustment, and a second selectable display element for expressing an opinion about the proposed adjustment for the first target contact;
detect input authorizing the proposed adjustment for the first target contact, wherein the input includes selection of the first selectable display element;
responsive to detecting input, initiate the proposed adjustment;
detect input expressing a favorable opinion of the proposed adjustment for the first target contact, wherein the input includes selection of the second selectable display element;
store information about the favorable opinion of the proposed adjustment for the first target contact;
identify, based on monitoring the information sources, further information about the second target contact; and
determine, after detecting input expressing the favorable opinion and based on both the further information about the second contact and the information about the favorable opinion of the proposed adjustment for the first target contact, a proposed adjustment for the second target contact, wherein the second proposed adjustment is an adjustment to a banking service being provided to the second target contact, and is of financial value to the second target contact.

18. The non-transitory computer-readable storage medium of claim 17, wherein to detect input relating to the proposed relationship, the instructions, when executed, further configure the one or more processors to:
receive a confirmation that the proposed adjustment was performed; and
update a data store to include information reflecting performance of the proposed adjustment for the first target contact.

19. The non-transitory computer-readable storage medium of claim 18, wherein the instructions, when executed, further configure the one or more processors to:
determine an expected trust score for the first target contact, the expected trust score indicating an expected likelihood of the first target to be receptive to marketing communications from the financial institution and being based on at least the information reflecting performance of the proposed adjustment;
determine that the expected trust score exceeds a predetermined threshold; and
based on the expected trust score exceeding the predetermined threshold, market a service to the first target contact.

20. (canceled)
